(19) United States
(12) Patent Application Publication
(10) Pub. No.: US 2023/0291110 A1
(43) Pub. Date: Sep. 14, 2023

(54) PRODUCTION METHOD FOR COMMUNICATION APPARATUS

(71) Applicant: DENSO CORPORATION, Kariya-city (JP)

(72) Inventors: Satoru WAKIYAMA, Kariya-city (JP); Akira SHINTAI, Kariya-city (JP); Toshifumi SHIROSAKI, Nisshin-shi (JP); Shuji HIRATA, Kariya-city (JP)

(21) Appl. No.: 18/175,701

(22) Filed: Feb. 28, 2023

(30) Foreign Application Priority Data
Mar. 9, 2022 (JP) 2022-036297

(51) Int. Cl. H01Q 9/04; H01Q 1/52; H01Q 1/48

(52) U.S. Cl. CPC H01Q 9/045; H01Q 1/526; H01Q 1/48

(57) ABSTRACT

A production method of a communication device includes a step of forming an antenna substrate and a circuit substrate independently from each other. The production method also includes a step of joining the antenna substrate and the circuit substrate simultaneously with joining of a power feeding pad and a power feeding path. In brief, the production method executes two discrete steps: forming the circuit substrate and forming the antenna substrate. This improves a production yield of the communication device as compared with the circuit substrate and the antenna substrate are produced in a single step.

### CROSS REFERENCE TO RELATED DOCUMENT

The present application claims the benefit of priority of Japanese Patent Application No. 2022-036297 filed on Mar. 9, 2022, the disclosure of which is incorporated in its entirety herein by reference.

### BACKGROUND

### 1 Technical Field

This disclosure relates generally to a production method of a communication apparatus.

### 2 Background Art

U.S. Pat. No. 10,157,807 B2 teaches a communication device equipped with a wireless communication integrated circuit mounted on a substrate, an antenna, and a wiring layer for use in electrically connecting electrodes of the wireless communication integrated circuit with the antenna.

The communication device also has a resin-molded layer which covers the substrate, the electrodes of the wireless communication integrated circuit, the antenna, and the wiring layer. The antenna is used to emit a transmit signal, as outputted by the wireless communication integrated circuit through the wiring layer, using an electromagnetic wave. The wireless communication integrated circuit works to receive a signal, as carried by an electromagnetic wave and received by the antenna, through the wiring layer.

In the communication device, the electrodes of the wireless communication integrated circuit and the antenna are, as described above, connected together using the wiring layer.

The production of the communication device which is achieved by sequentially performing a step of forming the wireless communication integrated circuit, a step of fabricating the antenna, and a step of fabricating the wiring layer will, however, result in a decrease in production yield thereof.

The above drawback is because, for instance, when the steps of fabricating the wiring layer and making the antenna are completed properly, but the step of forming the wireless communication integrated circuit fails, it is necessary to render the communication device itself defective.

### SUMMARY

It is, therefore, an object of this disclosure to provide a production method of a communication apparatus which has an improve production yield.

According to one aspect of this disclosure, there is provided a production method of a communication apparatus which comprises: (a) forming an antenna substrate which includes a first insulating substrate, an antenna, and a power feeding path, the first insulating substrate being made from an electrically insulating material in a form of a plate, the antenna being mounted on the first insulating substrate, the power feeding path being arranged on or in the first insulating substrate in connection with the antenna; (b) forming a circuit substrate which is discrete from the antenna substrate, the circuit substrate including a second insulating substrate and a communication integrated circuit, the second insulating substrate being made from an electrically insulating material in a form of a plate, the circuit substrate being disposed in the second insulating substrate and having a power feeding terminal for connection of the circuit substrate with the antenna through the power feeding path, the communication integrated circuit working to emit a signal from the antenna or receive a signal through the antenna; and (c) joining the antenna substrate and the circuit substrate together simultaneously with connection of the power feeding terminal with the power feeding path.

The above production method improves a production yield of the circuit substrate and the antenna substrate as compared with when they are produced in a single step.

According to another aspect of this disclosure, there is provided a production method of a communication apparatus which comprises: (a) forming an antenna substrate which includes a first insulating substrate, an antenna, and a power feeding path, the first insulating substrate being made from an electrically insulating material in a form of a plate, the antenna being mounted on the first insulating substrate, the power feeding path being arranged on or in the first insulating substrate in connection with the antenna; (b) forming a communication integrated circuit which is discrete from the antenna substrate, the communication integrated circuit including a power feeding terminal for connection of the communication integrated circuit with the antenna through the power feeding path, the communication integrated circuit working to emit a signal from the antenna or receive a signal through the antenna; and (c) joining the antenna substrate and the communication integrated circuit together simultaneously with connection of the power feeding terminal with the power feeding path.

The above production method improves a production yield of the communication integrated circuit and the antenna substrate as compared with when they are produced in a single step.

Reference marks or numbers in parentheses are attached to elements described in this application. Such reference marks or numbers merely represent an example of a correspondence relation between the elements and parts in the following embodiments. This disclosure is, therefore, not limited to the embodiments by use of the reference marks or numbers.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a cross sectional view taken along the line I-I in FIG. 3 which illustrates a communication device according to the first embodiment;

FIG. 2 is a perspective view which illustrates an antenna, a power feeding path, and an electromagnetic shielding member of a communication device in the first embodiment from which dielectric layers and ground vias are partially omitted;

FIG. 3 is an illustration, as viewed from an arrow III in FIG. 1, which shows a ground layer, through-holes in the ground layer, and a waveguide layer of a communication device in the first embodiment;

FIG. 4 is a cross sectional view taken along the line IV-IV in FIG. 1 which illustrates through-holes in a ground layer, an antenna layer, and a plurality of ground vias of a communication device in the first embodiment from which a dielectric layer is omitted;

FIG. 5 is a cross sectional view taken along the line V-V in FIG. 1 which illustrates a ground layer, through-holes, connecting flanged layer, and a plurality of ground vias of a communication device in the first embodiment from which a dielectric layer is omitted;

FIG. 6 is a cross sectional view taken along the line VI-VI in FIG. 1 which illustrates a ground layer, through-holes, a connecting elongated-plate layer, a plurality of ground vias, and a plurality of power feeding vias of a communication device in the first embodiment from which a dielectric layer is omitted;

FIG. 7 is a cross sectional view taken along the line VII-VII in FIG. 1 which illustrates a ground layer, through-holes, a connecting flanged layer, a plurality of ground vias, and a plurality of power feeding vias of a communication device in the first embodiment from which a dielectric layer is omitted;

FIG. 8 is a block diagram which illustrates a structure of an integrated circuit, an antenna layer, and power feeding paths of a communication device in the first embodiment;

FIG. 9 is a flowchart which illustrates a sequence of steps of a production method of a communication device in the first embodiment;

FIG. 10 is a cross sectional view which demonstrates a production step of a circuit substrate that is a semi-finished product of a communication device in the first embodiment;

FIG. 11 is a cross sectional view which demonstrates a production step of a ground layer and a waveguide layer of a communication device in the first embodiment;

FIG. 12 is a cross sectional view which demonstrates a production step of a ground layer and a waveguide layer of a communication device in the first embodiment;

FIG. 13 is a cross sectional view which demonstrates a production step of a plurality of ground vias of a communication device in the first embodiment;

FIG. 14 is a cross sectional view which demonstrates a production step of a plurality of ground vias of a communication device in the first embodiment;

FIG. 15 is a cross sectional view which demonstrates a production step of a dielectric layer of a communication device in the first embodiment;

FIG. 16 is a cross sectional view which demonstrates a production step of a ground layer and an antenna layer of a communication device in the first embodiment;

FIG. 17 is a cross sectional view which demonstrates a production step of a ground layer and an antenna layer of a communication device in the first embodiment;

FIG. 18 is a cross sectional view which demonstrates a production step of a plurality of ground vias and a power feeding via of a communication device in the first embodiment;

FIG. 19 is a cross sectional view which demonstrates a production step of a plurality of ground vias and a power feeding via of a communication device in the first embodiment;

FIG. 20 is a cross sectional view which demonstrates a production step of a dielectric layer of a communication device in the first embodiment;

FIG. 21 is a cross sectional view which demonstrates a production step of a ground layer and a connecting flanged layer of a communication device in the first embodiment;

FIG. 22 is a cross sectional view which demonstrates a production step of a ground layer and a connecting flanged layer of a communication device in the first embodiment;

FIG. 23 is a cross sectional view which demonstrates a production step of a plurality of ground vias and a power feeding via of a communication device in the first embodiment;

FIG. 24 is a cross sectional view which demonstrates a production step of a plurality of ground vias and a power feeding via of a communication device in the first embodiment;

FIG. 25 is a cross sectional view which demonstrates a production step of a dielectric layer of a communication device in the first embodiment;

FIG. 26 is a cross sectional view which demonstrates a production step of a ground layer and a connecting elongated layer of a communication device in the first embodiment;

FIG. 27 is a cross sectional view which demonstrates a production step of a ground layer and a connecting elongated layer of a communication device in the first embodiment;

FIG. 28 is a cross sectional view which demonstrates a production step of a dielectric layer of a communication device in the first embodiment;

FIG. 29 is a cross sectional view which demonstrates a production step of a ground layer and a connecting flanged layer of a communication device in the first embodiment;

FIG. 30 is a cross sectional view which illustrates a production step of a connecting layer of a communication device in the first embodiment and a structure of an antenna substrate borne by a supporting wafer;

FIG. 31 is a cross sectional view which illustrates a production step of a circuit substrate that is a semi-finished product of a communication device in the first embodiment;

FIG. 32 is a cross sectional view which illustrates a production step of a circuit substrate of a communication device in the first embodiment;

FIG. 33 is a cross sectional view which illustrates a production step of a resin-molded through-via in a circuit substrate of a communication device in the first embodiment;

FIG. 34 is a cross sectional view which illustrates a production step of a resin-molded through-via in a circuit substrate of a communication device in the first embodiment;

FIG. 35 is a cross sectional view which illustrates a production step of an integrated circuit and a resin-molded layer of a communication device in the first embodiment;

FIG. 36 is a cross sectional view which illustrates a production step of an insulating layer and a plurality of solder ball pads of a circuit substrate of a communication device in the first embodiment;

FIG. 37 is a cross sectional view which demonstrates a step of arranging a support wafer in fabrication of a circuit substrate of a communication device in the first embodiment;

FIG. 38 is a cross sectional view which demonstrates a step of removing a support wafer in fabrication of a circuit substrate of a communication device in the first embodiment;

FIG. 39 is a cross sectional view which demonstrates a step of producing a power feeding electrode and a ground electrode of a circuit substrate of a communication device in the first embodiment;

FIG. 40 is a cross sectional view which demonstrates a step of forming a connecting layer of a circuit substrate of a communication device in the first embodiment and also illustrates a portion of an electrical structure of the circuit substrate;

FIG. 41 is a cross sectional view which demonstrates a step of joining a circuit substrate and an antenna substrate in fabrication of a communication device in the first embodiment;

FIG. 42 is a cross sectional view which demonstrates a step of removing a support wafer in joining of a circuit substrate and an antenna substrate of a communication device in the first embodiment;

FIG. 43 is a cross sectional view which demonstrates a step of forming solder balls after a circuit substrate and an antenna substrate are joined together in fabrication of a communication device in the first embodiment;

FIG. 44 is a cross sectional view which illustrates a structure of a communication device according to the second embodiment;

FIG. 45 is a cross sectional view which demonstrates a structure of an antenna substrate in fabrication of a communication device in the second embodiment;

FIG. 46 is a cross sectional view which demonstrates a step of forming a circuit substrate in fabrication of a communication device in the second embodiment;

FIG. 47 is a cross sectional view which demonstrates a step of arranging a support wafer in fabrication of a circuit substrate of a communication device in the second embodiment;

FIG. 48 is a cross sectional view which demonstrates a step of joining a circuit substrate and an antenna substrate in fabrication of a communication device in the second embodiment;

FIG. 49 is a cross sectional view which demonstrates a step of joining a circuit substrate and an antenna substrate in fabrication of a communication device in the second embodiment;

FIG. 50 is a cross sectional view which demonstrates a step of removing a support wafer after a circuit substrate and an antenna substrate are joined together in fabrication of a communication device in the second embodiment;

FIG. 51 is a cross sectional view which demonstrates a step of forming solder balls after a circuit substrate and an antenna substrate are joined together in fabrication of a communication device in the second embodiment;

FIG. 52 is a cross sectional view which demonstrates a step of joining a circuit substrate and an integrated circuit together in fabrication of a communication device according to the third embodiment;

FIG. 53 is a cross sectional view which demonstrates a step of joining a circuit substrate and an integrated circuit together in fabrication of a communication device in the third embodiment;

FIG. 54 is a block diagram which illustrates a structure of an integrated circuit, an antenna, and a power feeding path of a communication device in another embodiment; and

FIG. 55 is a block diagram which illustrates a structure of an integrated circuit, a transmitting antenna layer, and a receiving antenna layer of a communication device in another embodiment.

### DESCRIPTION OF THE PREFERRED EMBODIMENTS

The embodiments will be described below with reference to the drawings. Parts of the embodiments functionally or structurally corresponding to each other or associated with each other will be denoted by the same reference numbers for the brevity of explanation.

### First Embodiment

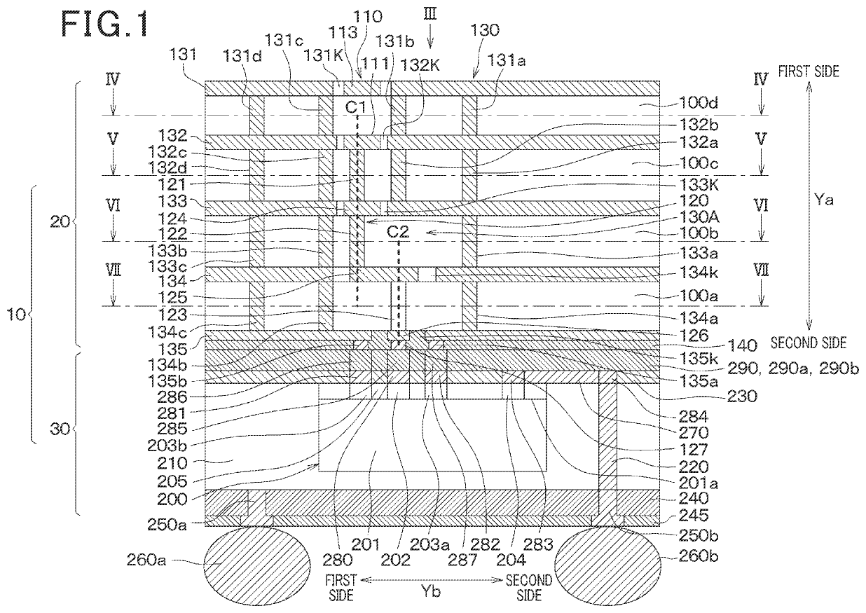

The communication device 10 according to the first embodiment will be described below with reference to FIGS. 1 to 43. The communication device 10, as illustrated in FIG. 1, includes the antenna substrate assembly 20 and the circuit substrate assembly 30.

In the following discussion, for the sake of convenience, a thickness direction of each of the antenna substrate assembly 20 and the circuit substrate assembly 30 will also be referred to as a thickness direction Ya; a direction traversing or perpendicular to the thickness direction Ya will also be referred to as a first crossing direction or a width direction Yb; a direction traversing or perpendicular to the thickness direction Ya and the width direction Yb will also be referred to as a second crossing direction or a depth direction Yc.

The antenna substrate assembly 20 includes the dielectric layers 100a, 100b, 100c, and 100d, the antenna 110, the power feeding path 120, the electromagnetic shield 130, and the insulating layer 140.

Each of the dielectric layers 100a, 100b, 100c, and 100d serves as an electrical insulating layer made of an electrical insulating material, such as polyimide or bismaleimide, which has a low dielectric property and an electrical insulating property. Each of the dielectric layers 100a, 100b, 100c, and 100d is shaped in the form of a plate which has a thickness, as measured in the thickness direction Ya, and spreads in the width direction Yb and the depth direction Yc.

Each of the dielectric layers 100a, 100b, 100c, and 100d will also be referred to as a first insulating substrate made from an electrically insulating resin material.

The dielectric layers 100a, 100b, 100c, and 100d are stacked on one another in the thickness direction Ya. Specifically, the dielectric layer 100d, the dielectric layer 100c, the dielectric layer 100b, and the dielectric layer 100a are laid to overlap each other in this order from the first side to the second side in the thickness direction Ya. The first side in the thickness direction Ya, as referred to therein, denotes one of sides of the communication device 10 which are opposed to each other in the thickness direction Ya and corresponds to an upper side of the communication device 10, as viewed in FIG. 1. The second side in the thickness direction Ya represents the other side of the communication device 10 which is opposed to the first side. The same is true for first and second sides in the width direction Yb and the depth direction Yc which will be referred to below.

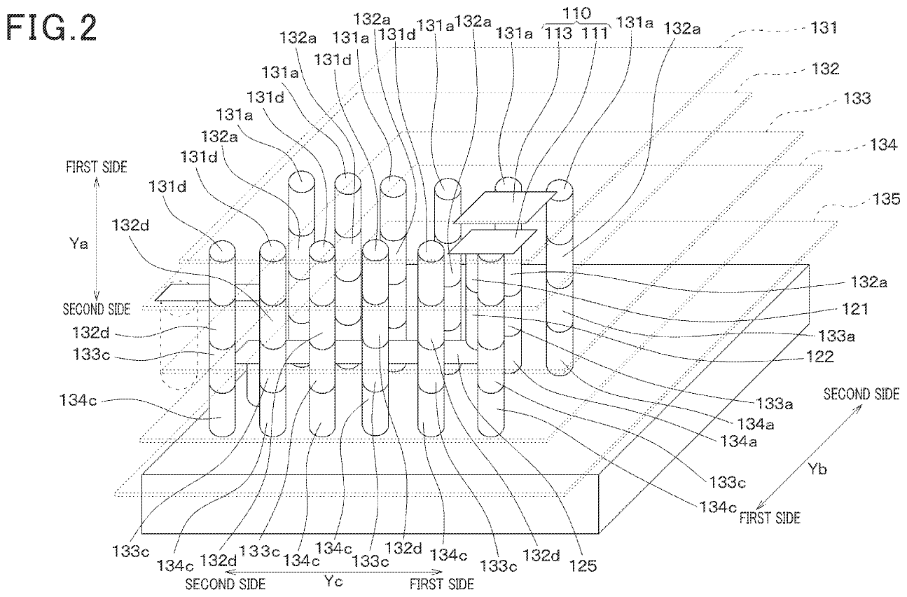

The antenna 110, as illustrated in FIGS. 1 and 2, includes the antenna layer 111 and the waveguide layer 113. The antenna layer 111 is shaped in the form of a thin film antenna element which has a thickness in the thickness direction Ya and spreads in the width direction Yb and the depth direction Yc.

FIG. 2 omits the dielectric layers 100a, 100b, 100c, and 100d and the ground vias 132d, 133c, 134c, 131b, and 132b in order to clarify the structure of the antenna 110 of the communication device 10.

The antenna layer 111 is shaped in the form of a plate extending in the depth direction Yc. The antenna layer 111 is oriented to have a normal line extending parallel to the thickness direction Ya. The antenna layer 111 is disposed between the dielectric layers 100c and 100d.

The antenna layer 111 is, as clearly illustrated in FIGS. 1 and 4, arranged inside the through-hole 132k of the ground layer 132. The antenna layer 111 is, therefore, electrically isolated from the ground layer 132.

The antenna layer 111 is connected to the power feeding pad 202 of the integrated circuit 200 of the circuit substrate assembly 30 using the power feeding path 120. The power feeding pad 202 serves as a power feeding terminal from which the transmit signal is delivered to the power feeding path 120 or to which a received signal is send from the power feeding path 120.

The waveguide layer 113 is located outside the dielectric layer 100d in the thickness direction Ya. The waveguide layer 113 is shaped in the form of a film which has a thickness in the thickness direction Ya and spreads in the width direction Yb and the depth direction Yc. The waveguide layer 113 is shaped in the form of a plate having a rectangular surface whose normal line extends in the thickness direction Ya.

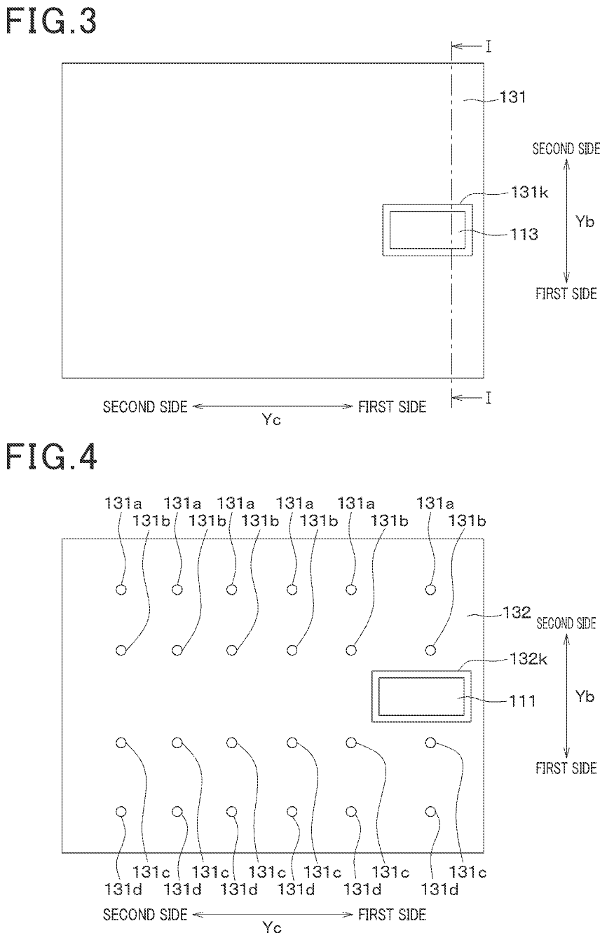

The waveguide layer 113 is, as clearly illustrated in FIGS. 1 and 3, disposed inside through-hole 131 of the ground layer 131. The waveguide layer 113 is electrically isolated from the ground layer 131. The waveguide layer 113 is located outside the antenna layer 111 in the thickness direction Y and covers or overlaps the antenna layer 111 through the dielectric layer 100d.

The waveguide layer 113 is, therefore, electrically isolated from the antenna layer 111.

The waveguide layer 113 works as a wave director to direct or guide an electromagnetic wave, as outputted from the antenna layer 111, toward the first side in the thickness direction Ya and also lead an electromagnetic wave, as coming from the first side in the thickness direction Ya, toward the antenna layer 111.

Each of the waveguide layer 113 and the antenna layer 111 is made from a conductive material containing copper.

The power feeding path 120 includes power feeding vias 121, 122, and 123, the connecting flanged layers 124 and 126, the connecting elongated-plate layer 125, and the power feeding electrode 127.

The power feeding via 121 is made of a through-hole via extending through the dielectric layer 100c in the thickness direction Ya. The power feeding via 121 is formed as a third power feeding conductor which is of a cylindrical shape centered at the axis line C1 (i.e., longitudinal center line) of the power feeding path 120. The power feeding via 121 in this embodiment is used as a first power feeding path. The axis line C1 is defined by an imaginary line extending in the thickness direction Ya.

The power feeding via 121 has a first end which faces the first side in the thickness direction Ya and connects with the antenna layer 111. The power feeding via 121 also has a second end which faces the second side in the thickness direction Ya and which connects with the connecting flanged layer 124. The connecting flanged layer 124 is disposed between the dielectric layers 100b and 100c.

The connecting flanged layer 124 is shaped in the form of a disc centered at the axis line C1. The connecting flanged layer 124 has a diameter around the axis line C1 which is larger than those of the power feeding vias 121 and 122. The connecting flanged layer 124, therefore, has a flange which protrudes radially outside the power feeding vias 121 and 122 around the axis line C1.

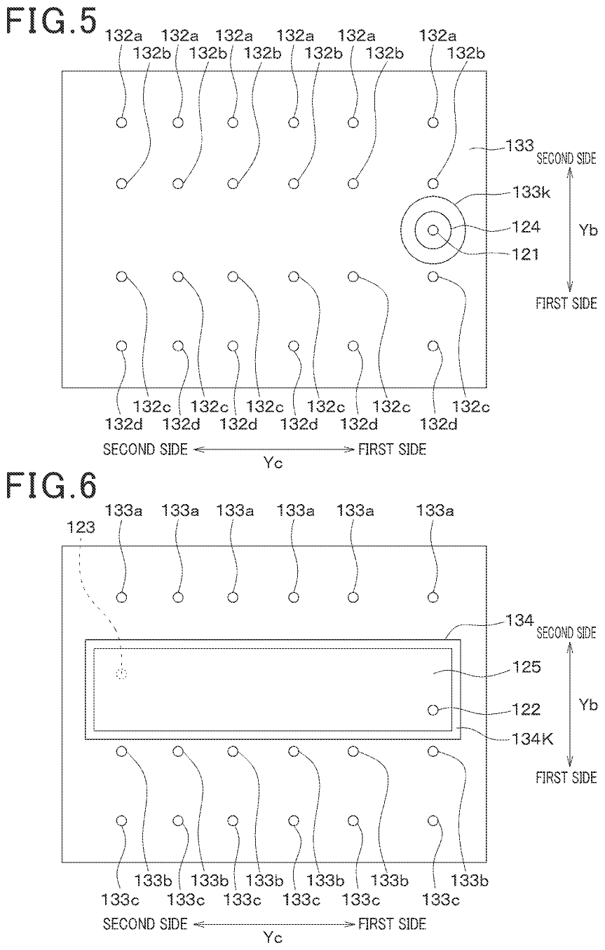

The connecting flanged layer 124 is, as clearly illustrated in FIGS. 1 and 5, disposed inside the through-hole 133k of the ground layer 133, so that it is electrically isolated from the ground layer 133.

The power feeding via 122 is designed as a through-hole via passing through the dielectric layer 100b in the thickness direction Ya. The power feeding via 122 is of a cylindrical shape centered at the the axis line C1 and works as a second power feeding conductor.

The power feeding via 122 has a first end which faces the first side in the thickness direction Ya which connects with the connecting flanged layer 124. The power feeding via 122, as clearly illustrated in FIGS. 1 and 6, also has a second end which faces the second side in the thickness direction Ya and connects with a portion of the connecting elongated-plate layer 125 which is located close to a first side of the communication device 10 in the depth direction Yc and also close to a first side of the communication device 10 in the width direction Yb.

The connecting elongated-plate layer 125 is, as can be seen in FIGS. 1 and 2, of a thin-film shape which has a thickness as measured in the thickness direction Ya and extends in the depth direction Yc. The connecting elongated-plate layer 125 serves as a first power feeding conductor which is, as clearly illustrated in FIG. 1, disposed between the dielectric layers 100a and 100b.

The connecting elongated-plate layer 125 is, as clearly illustrated in FIGS. 1 and 6, disposed inside the through-hole 134k of the ground layer 134, so that it is electrically isolated from the ground layer 134.

The power feeding via 123 is designed as a through-hole via which passes through the dielectric layer 100a in the thickness direction Ya. The power feeding via 123 is of a cylindrical shape centered at the axis line C2. The axis line C2 is defined by an imaginary line extending in the thickness direction Ya. The axis line C2 is offset from the axis line C1 both in the depth direction Yc and in the width direction Yb.

The power feeding via 123 has a first end which faces the first side in the thickness direction Ya and connects with a portion of the connecting elongated-plate layer 125 which is located closer to the second side in the depth direction Yc and also close to the second side in the width direction Yb. The power feeding via 123 has a second end which faces the second side in the thickness direction Ya and connects with the connecting flanged layer 126.

In this embodiment, the power feeding vias 122 and 121 extend in the thickness direction Ya between the connecting elongated-plate layer 125 and the antenna layer 111. A distance between the connecting elongated-plate layer 125 and the antenna layer 111 is selected to be 100 μm or more.

The connecting flanged layer 126 is shaped in the form of a disc centered at the axis line C2. The connecting flanged layer 126 has a diameter around the axis line C2 which is larger than that of the power feeding via 123. The connecting flanged layer 126, therefore, has a flange protruding outside the power feeding via 123 around the axis line C2.

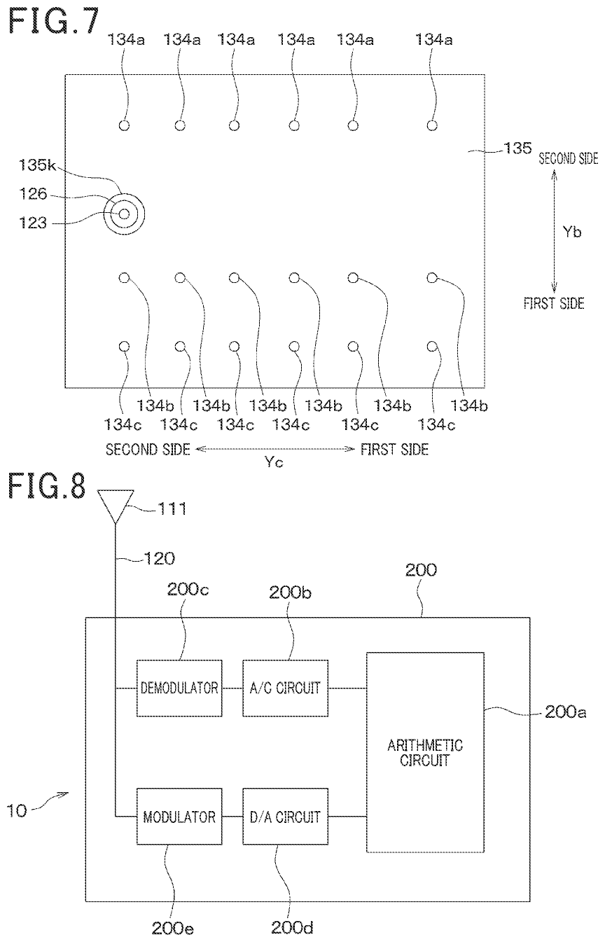

The connecting flanged layer 126 is, as can be seen in FIG. 1, located closer to the second side than the dielectric layer 100a is in the thickness direction Ya. The connecting flanged layer 126 is, as clearly illustrated in FIG. 7, disposed inside the through-hole 135k of the ground layer 135, so that it is electrically isolated from the ground layer 135. The connecting flanged layers 124 and 126 and the connecting elongated-plate layer 125 are each shaped in the form of a thin film which has a thickness in the thickness direction Ya and spreads both in the width direction Yb and in the depth direction Yc.

The power feeding electrode 127 is located closer to the second side in the thickness direction Ya than the connecting flanged layer 126 is. The power feeding electrode 127 has a first end which faces the first side in the thickness direction Ya and connects with the connecting flanged layer 126. The power feeding electrode 127 is shaped to protrude from the insulating layer 140 to the second side in the thickness direction Ya.

Each of the power feeding vias 121, 122, and 123, the connecting elongated-plate layer 125, the connecting flanged layers 124 and 126, and the power feeding electrode 127 is made from a conductive material containing copper.

The insulating layer 140 is of a plate shape which is located closer to the second side in the thickness direction Ya than the connecting flanged layer 126 and the ground layer 135 are and covers or overlaps the connecting flanged layer 126 and the ground layer 135 in the thickness direction Ya. The insulating layer 140 is made from an electrically insulating resin material, such as polyimide.

The electromagnetic shield 130 is, as clearly illustrated in FIGS. 1 and 2, designed as an electromagnetic shielding conductor including the ground layers 131, 132, 133, 134, and 135. The electromagnetic shield 130 has a plurality of ground vias 131a, 131b, 131c, 131d, 132a, 132b, 132c, 132d, 133a, 133b, 133c, 134a, 134b, and 134c formed therein.

Each of the ground layers 131, 132, 133, 134, and 135 is shaped in the form of a thin-film which has a thickness as measured in the thickness direction Ya and spreads or extends both in the width direction Yb and in the depth direction Yc. Each of the ground layers 131, 132, 133, 134, and 135 is made from a conductive material containing copper.

Specifically, the ground layer 131 is arranged closer to the first side in the thickness direction Ya than the dielectric layer 100d is. The ground layer 131 has formed therein the through-hole 131k which extends in the thickness direction Ya. The ground layer 131 surrounds the waveguide layer 113 both in the width direction Yb and in the depth direction Yc.

The ground layer 132 is disposed between the dielectric layers 100c and 100d. The ground layer 132, as can be seen in FIGS. 1 and 4, has formed therein the through-hole 132k which passes therethrough in the thickness direction Ya. The ground layer 132 surrounds the antenna layer 111 both in the width direction Yb and in the depth direction Yc.

The ground layer 133 is, as clearly illustrated in FIGS. 1 and 5, designed as a first ground conductor arranged between the dielectric layers 100b and 100c. The ground layer 133 has formed therein the through-hole 133k which passes therethrough in the thickness direction Ya. The ground layer 133 surrounds the connecting flanged layer 124 both in the width direction Yb and in the depth direction Yc.

The ground layer 134 is designed as a third ground conductor which is, as can be seen in FIGS. 1 and 6, disposed between the dielectric layers 100a and 100b. The ground layer 134 has formed therein the through-hole 134k which passes therethrough in the thickness direction Ya. The ground layer 134 surrounds the connecting elongated-plate layer 125 both in the width direction Yb and in the depth direction Yc.

The ground layer 135 is designed as a second ground conductor which is, as clearly illustrated in FIGS. 1 and 7, located closer to the second side in the thickness direction Ya than the dielectric layer 100a is. The ground layer 135 has formed therein the through-hole 135k which passes therethrough in the thickness direction Ya. The ground layer 135 surrounds the connecting flanged layer 126 both in the width direction Yb and in the depth direction Yc.

The ground vias 131a, 131b, 131c, and 131c are shaped to pass through the dielectric layer 100d in the thickness direction Ya. Each of the ground vias 131a, 131b, 131c, and 131c has a first end which faces the first side in the thickness direction Ya and connects with the ground layer 131. Each of the ground vias 131a, 131b, 131c, and 131c also has a second end which faces the second side in the thickness direction Ya and connects with the ground layer 132.

Each of the ground vias 131a and 131b is located closer to the second side in the width direction Yb than the antenna layer 111 is, while each of the ground vias 131c and 131d is located closer to the first side in the width direction Yb than the waveguide layer 113 is.

The ground vias 131a are, as clearly illustrated in FIG. 4, located closer to the second side in the width direction Yb than the ground vias 131b are. A respective adjacent two of the ground vias 131a are arranged at an interval of, for example, λ/4 or less away from each other where λ is a wavelength of a carrier wave which will be described later in detail.

The ground vias 131b are arranged at equal intervals away from each other in alignment in the depth direction Yc. An interval between a respective adjacent two of the ground vias 131b is selected to be, for example, λ/4 or less.

The ground vias 131c are arranged closer to the second side in the width direction Yb than the ground vias 131d are. The ground vias 131c are located at equal intervals away from each other in alignment in the depth direction Yc. An interval between a respective adjacent two of the ground vias 131c is selected to be, for example, λ/4 or less.

The ground vias 131d are arranged at equal intervals away from each other in alignment in the depth direction Yc. An interval between a respective adjacent two of the ground vias 131d is selected to be, for example, λ/4 or less.

Each of the ground vias 132a, 132b, 132c, and 132d is formed in the dielectric layer 100c to pass therethrough in the thickness direction Ya. Each of the ground vias 132a, 132b, 132c, and 132d has a first end in the thickness direction Ya which connects with the ground layer 132. Each of the ground vias 133a, 133b, 133c, and 133d also has a second end in the thickness direction Ya and connects with the ground layer 133.

The ground vias 132a and 132b are, as can be seen in FIG. 5, arranged closer to the second side in the width direction Yb than the power feeding via 121 is. The ground vias 132a are arranged closer to the second side in the width direction Yb than the ground vias 132b are.

The ground vias 132a are arranged at equal intervals away from each other in alignment in the depth direction Yc. An interval between a respective adjacent two of the ground vias 132a is selected to be, for example, λ/4 or less.

The ground vias 132b are arranged at equal intervals away from each other in alignment in the depth direction Yc. An interval between a respective adjacent two of the ground vias 132b is selected to be, for example, λ/4 or less.

Each of the ground vias 132a and the ground vias 132b works as a first electromagnetic shielding conductor which is shaped to extend in the thickness direction Ya and made from a conductive material containing copper.

The ground vias 132c and 132d are located closer to the first side in the width direction Yb than the power feeding via 121 is. The ground vias 132c are located closer to the second side in the width direction Yb than the ground vias 132d are.

The ground vias 132c are arranged at equal intervals away from each other in alignment in the depth direction Yc. An interval between a respective adjacent two of the ground vias 132c is selected to be, for example, λ/4 or less.

The ground vias 132d are arranged at equal intervals away from each other in alignment in the depth direction Yc. An interval between a respective adjacent two of the ground vias 132d is selected to be, for example, λ/4 or less.

Each of the ground vias 132c and the ground vias 132d works as a second electromagnetic shielding conductor which is shaped to extend in the thickness direction Ya and made from a conductive material containing copper.

Each of the ground vias 133a, 133b, and 133c is, as clearly illustrated in FIG. 1, formed in the dielectric layer 100b and passes therethrough in the thickness direction Ya. Each of the ground vias 133a, 133b, and 133c has a first end in the thickness direction Ya which connects with the ground layer 133. Each of the ground vias 133a, 133b, and 133c also has a second end in the thickness direction Ya which connects with the ground layer 134.

The ground vias 133a are, as can be seen in FIGS. 1 and 6, located closer to the second side in the width direction Yb than the power feeding via 122 is. The ground vias 133b and 133c are located closer to the first side in the width direction Yb than the power feeding via 122 is. The ground vias 133c are located closer to the first side in the width direction Yb than the ground vias 133b are.

The ground vias 133a are arranged at equal intervals away from each other in alignment in the depth direction Yc. An interval between a respective adjacent two of the ground vias 133a is selected to be, for example, λ/4 or less.

The ground vias 133b are arranged at equal intervals away from each other in alignment in the depth direction Yc. An interval between a respective adjacent two of the ground vias 133b is selected to be, for example, λ/4 or less.

The ground vias 133c are arranged at equal intervals away from each other in alignment in the depth direction Yc. An interval between a respective adjacent two of the ground vias 133c is selected to be, for example, λ/4 or less.

Each of the ground vias 133b and the ground vias 133c works as a fourth electromagnetic shielding conductor.

The ground vias 134a, 134b, and 134c are, as clearly illustrated in FIG. 1, formed in the dielectric layer 100a and pass therethrough in the thickness direction Ya. Each of the ground vias 134a, 134b, and 134c has a first end in the thickness direction Ya which connects with the ground layer 134. Each of the ground vias 134a, 134b, and 134c also has a second end in the thickness direction Ya which connects with the ground layer 135.

The ground vias 134a are, as can be seen in FIGS. 1 and 7, located closer to the second side in the width direction Yb than the power feeding via 123 is. Each of the ground vias 134a works as a fifth ground conductor.

The ground vias 134b and 134c are located closer to the first side in the width direction Yb than the power feeding via 123 is. The ground vias 134b are located closer to the second side in the width direction Yb than the ground vias 134c are.

The ground vias 134a are arranged at equal intervals away from each other in alignment in the depth direction Yc. An interval between a respective adjacent two of the ground vias 134a is selected to be, for example, λ/4 or less.

The ground vias 134b are arranged at equal intervals away from each other in alignment in the depth direction Yc. An interval between a respective adjacent two of the ground vias 134b is selected to be, for example, λ/4 or less.

The ground vias 134c are arranged at equal intervals away from each other in alignment in the depth direction Yc. An interval between a respective adjacent two of the ground vias 134c is selected to be, for example, λ/4 or less.

The electromagnetic shield 130 is, as illustrated in FIG. 1, equipped with the ground electrodes 135a and 135b. The ground electrodes 135a and 135b are located closer to the second side in the thickness direction Ya than the ground layer 135 is. The ground electrodes 135a and 135b connect with the ground layer 135.

The ground electrode 135a is located closer to the second side in the width direction Yb than the power feeding electrode 127 is. The ground electrode 135b is located closer to the first side in the width direction Yb than the power feeding electrode 127 is. The ground electrodes 135a and 135b are electrically insulated from the power feeding electrode 127.

The ground electrodes 135a and 135b, as will be described later in detail, connect with the grounding pads 203a and 203b on the integrated circuit 200, so that the ground electrodes 135a and 135b, in other words, the electromagnetic shield 130 is connected to ground of the integrated circuit 200.

The circuit substrate assembly 30, as clearly illustrated in FIG. 1, includes the integrated circuit 200, the resin-molded layer 210, the resin-molded through-via 220, the insulating layers 230 and 240, the resin-molded layer 245, the solder ball pads 250a and 250b, and the solder balls 260a and 260b.

The circuit substrate assembly 30, as can be seen in FIG. 1, also includes the redistribution layer 270, the external connecting vias 280, 281, 282, 283, and 284, the power feeding electrode 285, the ground electrode 286 and 287 and the connecting layer 290.

The integrated circuit 200 is designed as a communication integrated circuit including the semiconductor device 201, the power feeding pad 202, the grounding pads 203a and 203b, the signaling pad 204, and the protective film 205.

The semiconductor device 201 is shaped in the form of a thin film which has a thickness in the thickness direction Ya and spreads both in the width direction Yb and in the depth direction Yc. Specifically, the semiconductor device 201 is equipped with a semiconductor wafer shaped in the form of a thin film.

The semiconductor wafer has a first major surface and a second major surface which are opposed to each other in the thickness direction Ya. The first major surface faces the first side in the thickness direction Ya and serves as the circuit surface 201a which is flat and spreads in the width direction Yb and the depth direction Yc. The circuit surface 201a has a communication circuit formed thereon.

The communication device 10, as illustrated in FIG. 8, also includes the arithmetic circuit 200a, the analog-to-digital converter 200b, the demodulating circuit 200c, the modulation circuit 200e, and the digital-to-analog converter 200d.

The arithmetic circuit 200a outputs transmit data. The digital-to-analog converter 200d works to change the transmit data into an analog signal. The modulation circuit 200e works to modulate an output from the digital-to-analog converter 200d using a carrier wave and output it to the power feeding pad 202 in the form of a modulated signal.

The demodulating circuit 200c works to demodulate a received signal, as transmitted from the power feeding pad 202, using a carrier wave and output it in the form of a demodulated signal. The analog-to-digital converter 200b works to change the output from the demodulating circuit 200c into a digital signal. The arithmetic circuit 200a uses the output from the analog-to-digital converter 200b to execute a variety of tasks.

The power feeding pad 202 serves as a connecting terminal formed on the circuit surface 201a of the semiconductor device 201. The power feeding pad 202 constitutes a feed point into which a signal is inputted which arises from a transmit signal outputted from the modulation circuit 200e and then is received by the antenna 110.

The carrier waves for use in modulating the transmit signal and demodulating the received signal have a frequency of 24 GHz or a frequency of 76 GHz to 81 GHz.

The grounding pads 203a and 203b serve as connecting terminals formed on the circuit surface 201a of the semiconductor device 201. The grounding pads 203a and 203b are connected to ground of the communication circuit of the integrated circuit 200.

The signaling pad 204 is formed on the circuit surface 201a of the semiconductor device 201. The signaling pad 204 serves as a connecting terminal from which various types of control signals, as transmitted from the arithmetic circuit 200a, are outputted to another electronic controller or through which various types of control signals, as outputted from another electronic controller, are delivered to the arithmetic circuit 200a.

The power feeding pad 202, the grounding pads 203a and 203b, and the signaling pad 204 are made from a conductive material containing copper.

The protective film 205, in the form of a thin film, covers the semiconductor device 201 from the first side in the thickness direction Ya. The protective film 205 is made from an electrically insulating resin material.

The resin-molded layer 210 serves as a second insulating substrate which is of a plate shape and made from an electrically insulating resin material, such as epoxy resin. Specifically, the resin-molded layer 210 is in the shape of a plate which has a thickness in the thickness direction Ya and spreads both in the width direction Yb and in the depth direction Yc.

The resin-molded layer 210 covers the semiconductor device 201 from the second side in the thickness direction Ya and also covers a combination of the semiconductor device 201 and the protective film 205 from the first and second sides both in the width direction Yb and in the depth direction Yc.

The resin-molded through-via 220 is formed in the resin-molded layer 210 and passes therethrough in the thickness direction Ya. The resin-molded through-via 220 is made from a conductive material containing copper.

The insulating layer 230 is shaped in the form of a thin film which covers the resin-molded layer 210 from the first side in the thickness direction Ya. The insulating layer 240 is shaped in the form of a thin film which covers the resin-molded layer 210 from the second side in the thickness direction Ya.

Each of the insulating layers 230 and 240 is shaped in the form of a plate which has a thickness in the thickness direction Ya and spreads both in the width direction Yb and in the depth direction Yc. Each of the insulating layers 230 and 240 is made from an electrically insulating resin material, such as polyimide. The resin-molded layer 245 covers the insulating layer 240 from the second side in the thickness direction Ya.

The solder ball pads 250a and 250b are formed to pass through the insulating layer 240 in the thickness direction Ya. The solder ball pad 250b connects with a second end of the resin-molded through-via 220 which faces the second side in the thickness direction Ya.

The solder ball 260a is located closer to the second side in the thickness direction Ya than the solder ball pad 250a is. The solder ball 260a connects with the solder ball pad 250a.

The solder ball 260b is located closer to the second side in the thickness direction Ya than the solder ball pad 250b is. The solder ball pad 250b connects with the solder ball pad 250b.

The external connecting via 280 is arranged to pass through the insulating layer 230 in the thickness direction Ya. The external connecting via 280 has a second end which faces the second side in the thickness direction Ya and connects with the power feeding pad 202 of the integrated circuit 200. The external connecting via 280 also has a first end which faces the first side in the thickness direction Ya and connects with the power feeding electrode 285.

The external connecting via 281 is arranged to pass through the insulating layer 230 in the thickness direction Ya. The external connecting via 281 has a second end which faces the second side in the thickness direction Ya and connects with the grounding pad 203b of the integrated circuit 200. The external connecting via 281 also has a first end which faces the first side in the thickness direction Ya and connects with the ground electrode 286.

The external connecting via 282 is arranged to pass through the insulating layer 230 in the thickness direction Ya. The external connecting via 282 has a second end which faces the second side in the thickness direction Ya and connects with the grounding pad 203a of the integrated circuit 200. The external connecting via 282 also has a first end which faces the first side in the thickness direction Ya and connects with the ground electrode 287.

The external connecting via 283 is arranged to pass through the insulating layer 230 in the thickness direction Ya. The external connecting via 283 has a second end which faces the second side in the thickness direction Ya and connects with the signaling pad 204 of the integrated circuit 200. The external connecting via 283 also has a first end which faces the first side in the thickness direction Ya and connects with a first end of the redistribution layer 270 which faces the first side in the width direction Yb.

The redistribution layer 270 is shaped to extend within the insulating layer 230 in the width direction Yb. The redistribution layer 270 has a first end which faces the first side in the width direction Yb and connects with the external connecting via 283. The redistribution layer 270 also has a second end which faces the second side in the width direction Yb and connects with the first end of the resin-molded through-via 220 which faces the first side in the thickness direction Ya.

Each of the redistribution layer 270, the external connecting vias 280, 281, 282, 283, and 284, the power feeding electrode 285 and the ground electrodes 286 and 287 are made from a conductive material containing copper.

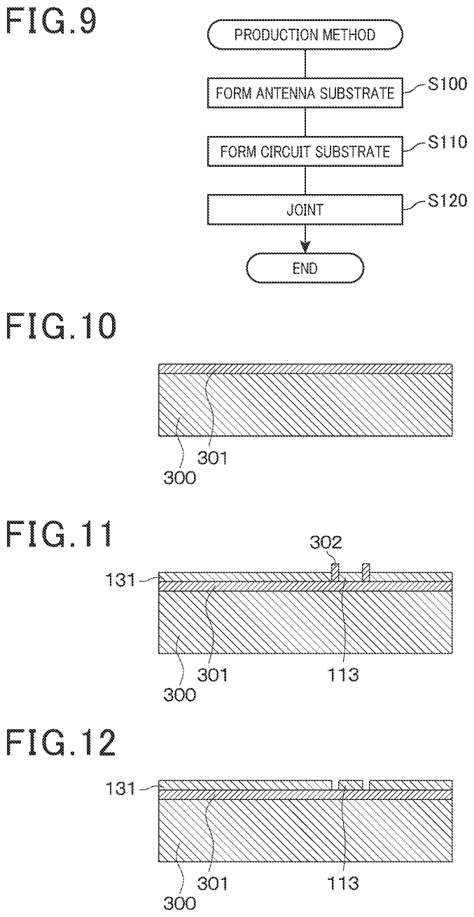

A production method of the communication device 10 will be described below with reference to FIGS. 9 to 43. FIG. 9 is a flowchart of a sequence of steps of producing the communication device 10. FIGS. 10 to 43 are sectional views for demonstrating the production steps of the communication device 10.

Referring to FIG. 9, in step S100 (i.e., first production step), the antenna substrate 20A is formed. Specifically, an adhesive material is, as demonstrated in FIG. 10, applied to an upper surface of the supporting wafer 300 to form the temporary bonding layer 301.

Next, the photoresist 302 is, as illustrated in FIG. 11, produced on an upper surface of the temporary bonding layer 301. The photoresist 302 is of a frame shape and extends through the temporary bonding layer 301 in a vertical direction. The photoresist 302 is used to form the waveguide layer 113 therewithin. The vertical direction, as referred to herein, coincides with the thickness direction Ya. An area of the upper surface of the temporary bonding layer 301 other than the photoresist 302 is plated with copper. Specifically, a thin film made from a conductive material containing copper is formed on the area of the upper surface of the temporary bonding layer 301 which is unoccupied by the photoresist 302. The thin film spreads both in the width direction Yb and in the depth direction Yc.

Consequently, the ground layer 131 is, as illustrated in FIG. 12, formed outside the photoresist 302 on the upper surface of the temporary bonding layer 301. Simultaneously, the waveguide layer 113 is formed inside the photoresist 302 on the upper surface of the temporary bonding layer 301.

The photoresist 302 is removed from the temporary bonding layer 301 upward in the thickness direction Ya, as viewed in FIG. 12.

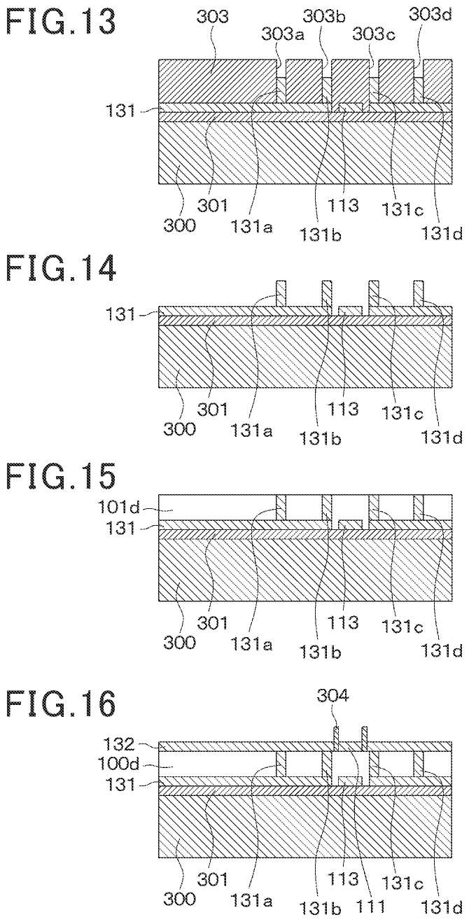

Subsequently, the photoresist 303 is, as illustrated in FIG. 13, produced in the form of a thin film on upper surfaces of the ground layer 131 and the waveguide layer 113. Additionally, the through-holes 303a, 303b, 330c, and 303d are formed in the photoresist 303. The through-holes 303a, 303b, 330c, and 303d pass through a thickness of the photoresist 303 in the vertical direction.

Each of the through-holes 303a, 303b, 330c, and 303d is used to form a corresponding one of the ground vias 131a, 131 b, 131c, and 131c.

The through-holes 303a are arranged adjacent each other in the depth direction Yc. Similarly, the through-holes 303b are arranged adjacent each other in the depth direction Yc. The through-holes 303c are arranged adjacent each other in the depth direction Yc. The through-holes 303d are arranged adjacent each other in the depth direction Yc.

The through-holes 303a, the through-holes 303b, the through-holes 303c, and the through-holes 303d are, as clearly illustrated in FIG. 13, filled with copper plating materials. This forms the ground vias 131a, the ground vias 131b, the ground vias 131c, and the ground via 131d.

Subsequently, the photoresist 303 which is disposed on the ground layer 131 and the waveguide layer 113 and faces to the first side in the thickness direction Ya is, as clearly illustrated in FIG. 14, removed therefrom.

The electrically insulating material 101d is, as can be seen in FIG. 15, disposed over the ground layer 131 and the waveguide layer 113 to fully cover the ground layer 131, the waveguide layer 113, and the ground vias 131a, 131b, 131c, and 131c.

Next, an upper end of each of the ground vias 131a, 131b, 131c, and 131c and an upper portion of the electrically insulating material 101d are cut into desired shapes.

The ground vias 131a, 131b, 131c, and 131c are, therefore, shaped to have flat upper surfaces. Similarly, the electrically insulating material 101d is shaped to have a flat upper surface in the form of the dielectric layer 100d. The upper ends of the ground vias 131a, 131b, 131c, and 131c are, as clearly illustrated in FIG. 15, exposed outside the upper surface of the dielectric layer 100d.

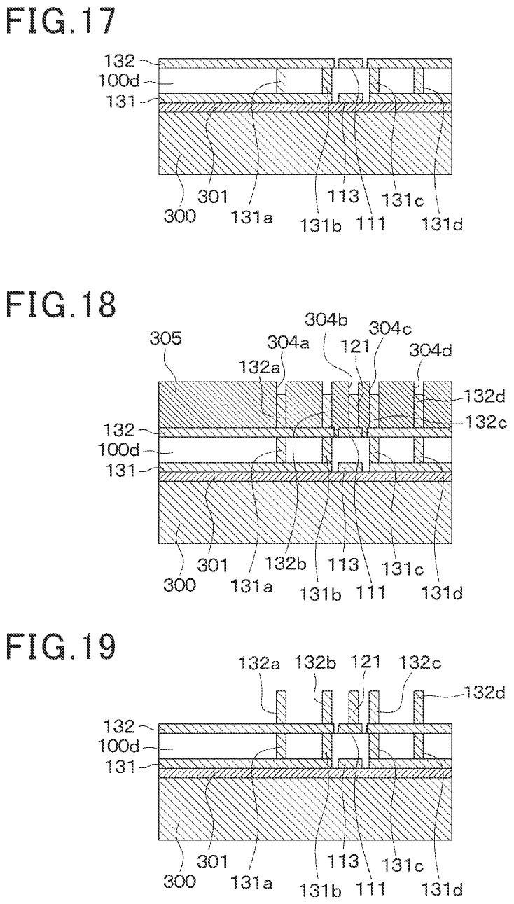

The frame-shaped photoresist 304 is, as demonstrated in FIG. 16, formed on the outer surface of the dielectric layer 100d in the same way as on the ground layer 131 and the waveguide layer 113. The outer surface of the dielectric layer 100d faces in the second side in the dielectric layer 100d. The outer surface of the dielectric layer 100d is, as demonstrated in FIG. 17, plated with copper to form the antenna layer 111 and the ground layer 132.

FIG. 16 illustrates the photoresist 304, the antenna layer 111, and the ground layer 132 which are formed on the upper surface of the dielectric layer 100d. FIG. 17 illustrates the antenna layer 111 and the ground layer 132 which are completed by removing the photoresist 304 from the upper surface of the dielectric layer 100d.

Subsequently, the photoresist 305 is, as demonstrated in FIG. 18, produced on the antenna layer 111 and the ground layer 132. The through-holes 304a, 304b, 304c, and 304d are formed in the photoresist 305. The photoresist 305 is then placed with copper in the same way as that in which the ground vias 131a to 131d are produced, thereby forming, as illustrated in FIG. 19, the ground vias 132a, 132b, 132c, and 132d, and the power feeding via 121.

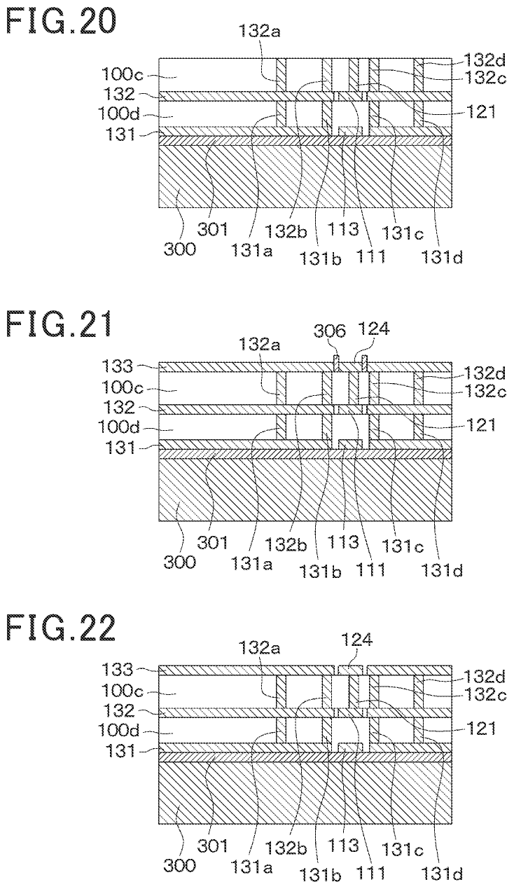

Subsequently, an electrically insulating material is, as illustrated in FIG. 20, disposed to fully cover the antenna layer 111, the ground layer 132, the power feeding via 121, and the ground vias 132a, 132b, 132c, and 132d.

An upper end of each of the power feeding via 121 and the ground vias 132a, 132b, 132c, and 132d is cut into desired shapes. Simultaneously, an upper surface of the electrically insulating material is cut into a desired shape. The power feeding via 121 and the ground vias 132a, 132b, 132c, and 132d are, therefore, shaped to have flat upper surfaces. The electrically insulating material is also shaped to have a flat upper surface, thereby completing the dielectric layer 100c. Consequently, the upper surfaces of the power feeding via 121 and the ground vias 132a, 132b, 132c, and 132d are, clearly illustrated in FIG. 20, exposed outside the upper surface of the dielectric layer 100c. The upper surfaces of the power feeding via 121 and the ground vias 132a, 132b, 132c, and 132d face the second side in the thickness direction Ya.

The power feeding via 121, the ground vias 132a, 132b, 132c, and 132d, and the electrically insulating material, therefore, have the upper flat end surfaces, so that the power feeding via 121 and the ground vias 132a, 132b, 132c, and 132d are exposed outside the dielectric layer 100c toward the second side in the thickness direction Ya.

The power feeding via 121 and the ground vias 132a, 132b, 132c, and 132d are arranged at the same position as that of the dielectric layer 100c in the thickness direction Ya. In other words, the power feeding via 121, the ground vias 132a, 132b, 132c, and 132d, and the dielectric layer 100c are arranged in alignment with each other in a direction perpendicular to the thickness direction Ya (i.e., the width direction Yb).

Subsequently, the frame-shaped photoresist 306 is, as demonstrated in FIG. 21, produced on the upper surface of the dielectric layer 100c and the plated with copper, thereby forming, as demonstrated in FIG. 22, the connecting flanged layer 124 and the ground layer 133.

FIG. 21 illustrates the photoresist 306, the connecting flanged layer 124, and the ground layer 133 which are formed on the dielectric layer 100c. FIG. 22 illustrates the connecting flanged layer 124 and the ground layer 133 after the photoresist 305 is removed from the upper surface of the dielectric layer 100c.

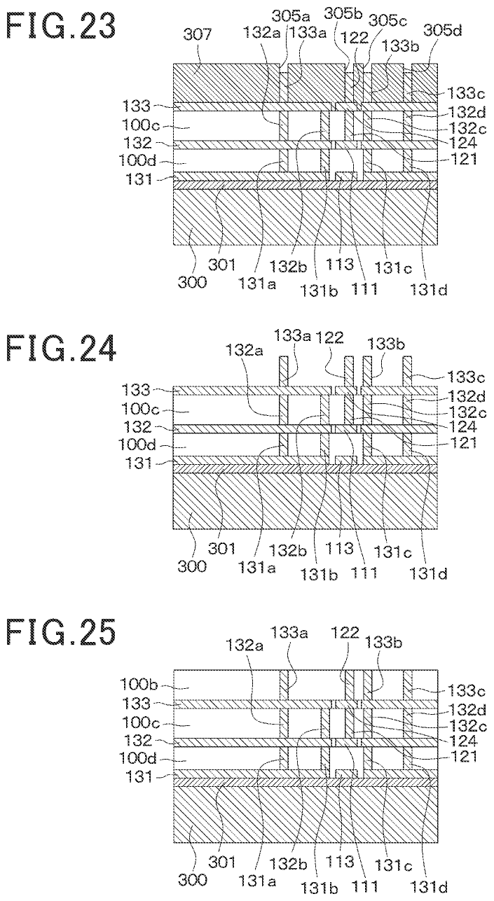

Subsequently, the photoresist 307 is, as demonstrated in FIG. 23, produced on the connecting flanged layer 124 and the ground layer 133. The photoresistor 307 has the through-holes 305a, 305b, 305c, and 305d formed therein. The photoresist 307 is then placed with copper in the same way as that in which the ground vias 131a to 131d are produced, thereby forming, as illustrated in FIG. 24, the ground vias 133a, 133b, and 133c and the power feeding via 122.

FIG. 23 illustrates the ground vias 133a, 133b, and 133c and the power feeding via 122 formed in the through-holes 305a, 305b, 305c, and 305d of the photoresist 307. FIG. 24 illustrates the ground vias 133a, 133b, and 133c and the power feeding via 122 which are exposed outside the connecting flanged layer 124 and the ground layer 133 after removal of the photoresist 307.

An electrically insulating material is, as can be seen in FIG. 25, disposed over the ground layer 133, the connecting flanged layer 124, the ground vias 133a, 133b, and 133c, and the power feeding via 122 to fully cover them.

Next, an upper end of each of the ground vias 133a, 133b, and 133c and the power feeding via 122 and an upper portion of the electrically insulating material are cut into desired shapes. Specifically, the ground vias 133a, 133b, and 133c, the power feeding via 122, and the electrically insulating material 100b are shaped to have flat upper end surfaces. The electrically insulating material completes the dielectric layer 100b. The flat upper end surfaces of the ground vias 133a, 133b, and 133c and the power feeding via 122 are, therefore, as illustrated in FIG. 25, exposed outside the upper surface of the dielectric layer 100b. The flat upper end surfaces of the ground vias 133a, 133b, and 133c and the power feeding via 122 face the second side in the thickness direction Ya.

The ground vias 133a, 133b, and 133c and the power feeding via 122 are arranged at the same position as that of the dielectric layer 100b in the thickness direction Ya. In other words, the ground vias 133a, 133b, and 133c, the power feeding via 122, and the dielectric layer 100b are arranged in alignment with each other in a direction perpendicular to the thickness direction Yb (i.e., the width direction Yb).

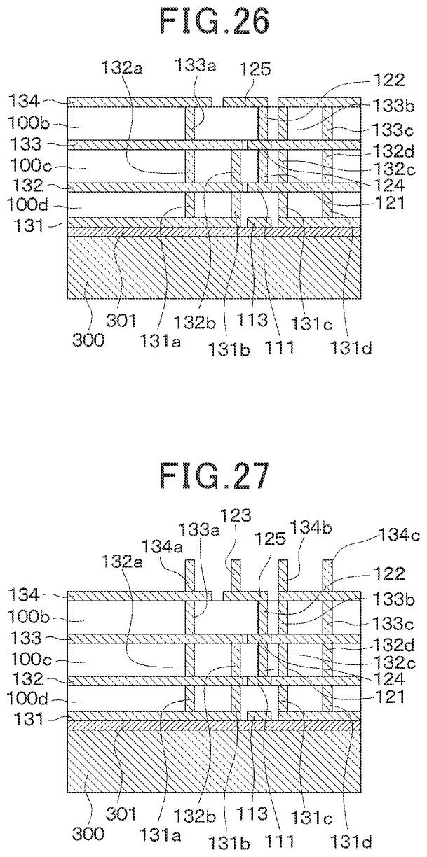

Subsequently, the connecting elongated-plate layer 125, the ground layer 134, the ground vias 134a, 134b, and 134c, and the power feeding via 123 are, as can be seen in FIGS. 26, and 27, formed using copper-plating techniques.

FIG. 26 illustrates the connecting elongated-plate layer 125 and the ground layer 134 which are formed on the dielectric layer 100b. FIG. 27 illustrates the ground vias 134a, 134b, and 134c and the power feeding via 123 which are formed on the ground layer 134 and the connecting elongated-plate layer 125.

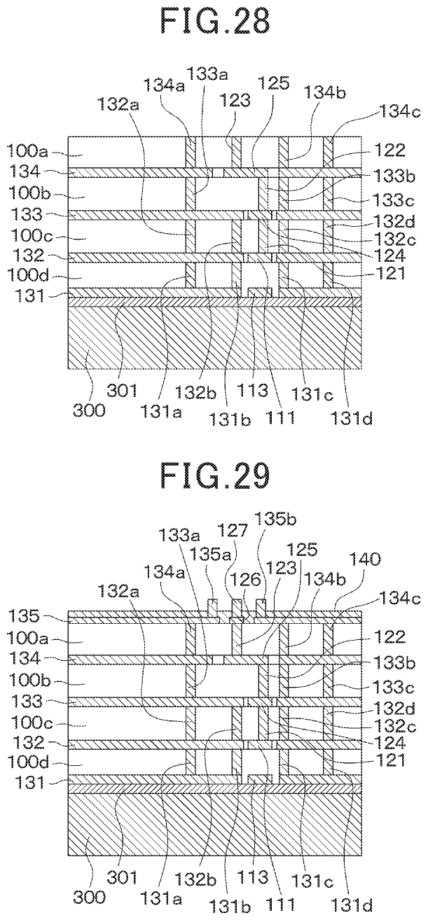

Subsequently, an electrically insulating material is, as illustrated in FIG. 28, disposed over the ground layer 134, the connecting elongated-plate layer 125, the ground vias 134a, 134b, and 134c, and the power feeding via 123 to fully cover them.

An upper end of each of the power feeding via 123 and the ground vias 134a, 134b, and 134c and an upper portion of the electrically insulating material are cut into desired shapes. Specifically, the power feeding via 123, the ground vias 134a, 134b, and 134c, and the electrically insulating material are shaped to have flat upper end surfaces. The electrically insulating material completes the dielectric layer 100a. The flat upper end surfaces of the power feeding via 123 and the ground vias 134a, 134b, and 134c are, therefore, as illustrated in FIG. 28, exposed outside the upper surface of the dielectric layer 100a. The flat upper end surfaces of the power feeding via 123 and the ground vias 134a, 134b, and 134c face the second side in the thickness direction Ya.

The power feeding via 123 and the ground vias 134a, 134b, and 134c are arranged at the same position as that of the dielectric layer 100c in the thickness direction Ya. In other words, the power feeding via 123, the ground vias 134a, 134b, and 134c, and the dielectric layer 100c are arranged in alignment with each other in a direction perpendicular to the thickness direction Yb (i.e., the width direction Yb).

Subsequently, the dielectric layer 100a, the ground layer 135, the connecting flanged layer 126, the ground electrodes 135a and 135b, the power feeding electrode 127, and the insulating layer 140 are, as can be seen in FIGS. 28 and 29 formed using copper-plating techniques.

FIG. 28 demonstrates the dielectric layer 100a formed on the connecting elongated-plate layer 125 and the ground layer 134. FIG. 29 demonstrates the ground layer 135, the connecting flanged layer 126, the ground electrodes 135a and 135b, and the power feeding electrode 127 which are formed on the dielectric layer 100a.

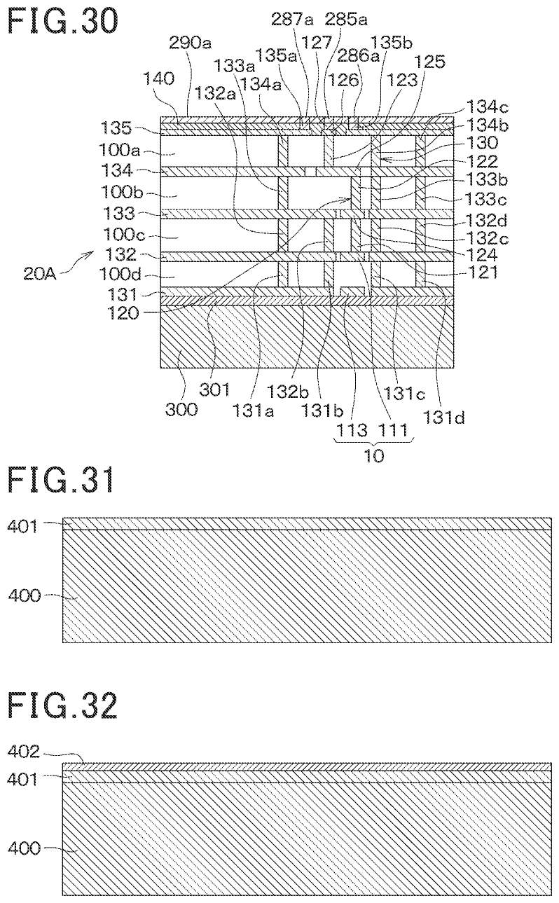

The ground electrodes 135a and 135b and the power feeding electrode 127 are, as can be seen in FIG. 30, shaped to complete the insulating layer 140, the ground electrodes 286a and 287a, the power feeding electrode 285a, and the connecting layer 290a.

Specifically, the insulating layer 140 is formed in the shape of a film to cover the upper surfaces of the ground layer 135 and the connecting flanged layer 126. The ground electrode 286a is formed on the ground electrode 135b. The ground electrode 287a is formed on the ground electrode 135a. The power feeding electrode 285a is formed on the power feeding electrode 127. The connecting layer 290a is formed in the shape of a film which covers the upper surface of the insulating layer 140.

In other words, the ground electrodes 286a and 135b are connected together. The ground electrodes 287a and 135a are connected together. The power feeding electrodes 285a and 127 are connected together. The ground electrodes 286a and 287a, the power feeding electrode 285a, and the connecting layer 290a are embedded in the connecting layer 290a.

The connecting layer 290a is made from a thermosetting resin, such as Non-Conductive Film (NCF). In the above way, the antenna substrate 20A is produced on the supporting wafer 300 and the temporary bonding layer 301.

The antenna substrate 20A is made up of the dielectric layers 100a, 100b, 100c, and 100d, the antenna 110, the power feeding path 120, the electromagnetic shield 130, and the insulating layer 140.

The antenna substrate 20A is a semi-finished product, that is, a workpiece which is fabricated in the process of manufacturing of the communication device 10 and includes the antenna 110, while the antenna substrate assembly 20 is a part of the communication device including the antenna 110 after completed in the manufacturing process.

In the step S110 (i.e., second production step) illustrated in FIG. 9, the circuit substrate 30A is produced. First, adhesive material is, as illustrated in FIG. 31, applied to an upper surface of the support wafer 400 to form the temporarily bonding layer 401. Subsequently, the plated seed layer 402 is, as clearly illustrated in FIG. 32, formed on an upper surface of the temporarily bonding layer 401.

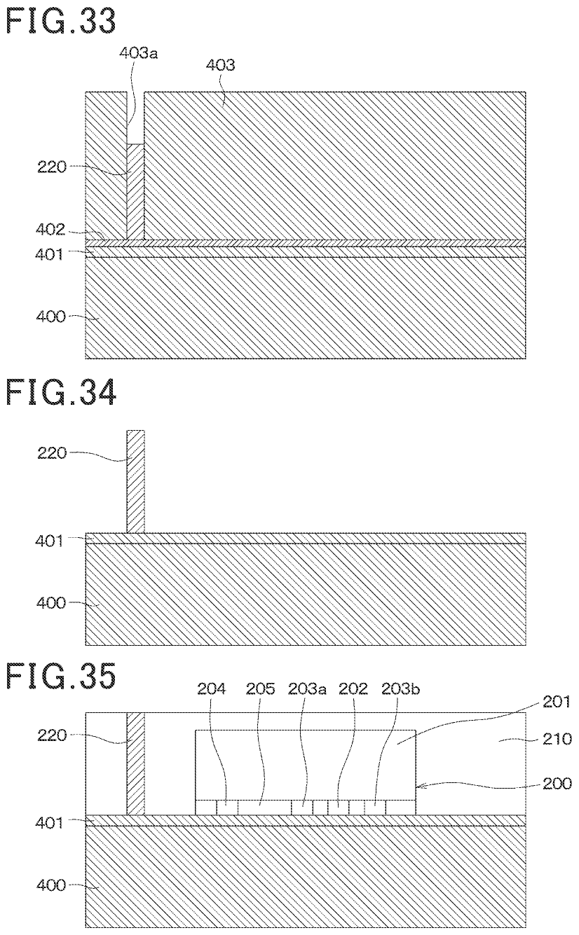

Subsequently, the photoresist 403 is, as illustrated in FIGS. 32 and 33, produced on an upper surface of the plated seed layer 402 in the same way as described above. The photoresist 403 has the through-hole 403a formed therein. The through-hole 403 is plated with copper to fabricate the resin-molded through-via 220.

Subsequently, the integrated circuit 200 is, as illustrated in FIG. 35, disposed on the temporarily bonding layer 401. The resin-molded layer 210 is then formed to cover the integrated circuit 200 from above.

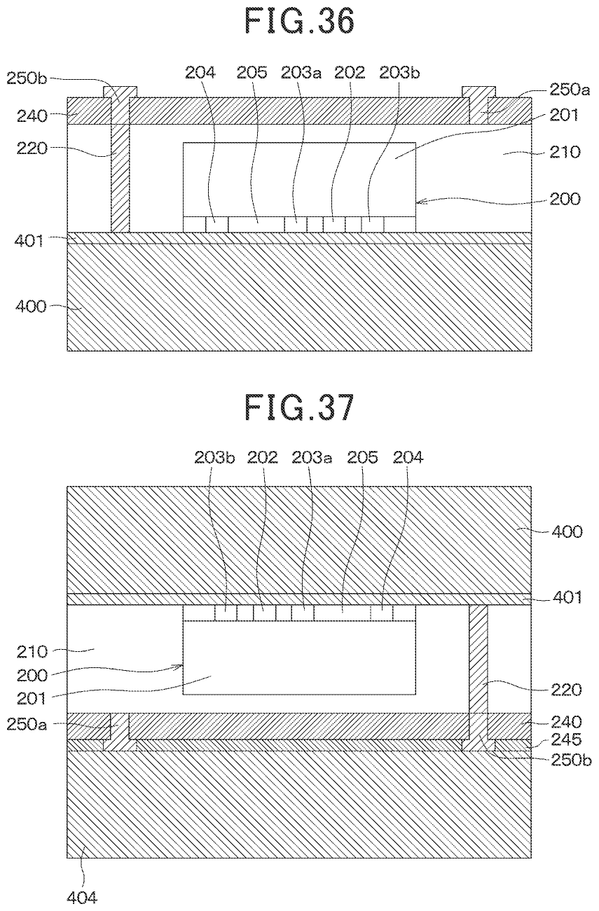

Subsequently, the insulating layer 240 and the solder ball pads 250a and 250b are, as illustrated in FIG. 36, formed on the resin-molded layer 210.

Subsequently, the support wafer 404 is, as illustrated in FIG. 37, formed beneath the resin-molded layer 245.

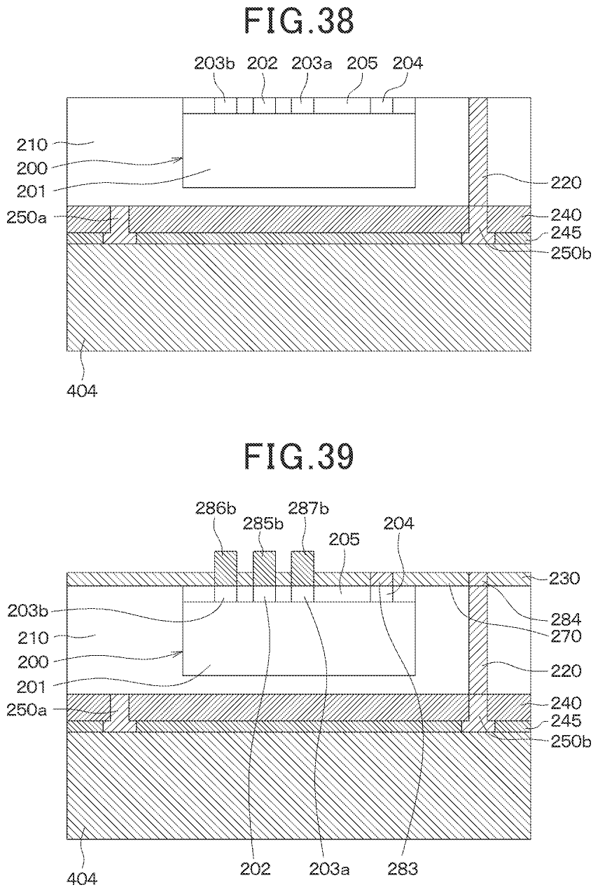

Subsequently, the temporarily bonding layer 401 and the support wafer 400 are, as clearly illustrated in FIG. 38, removed from the upper surface of the resin-molded layer 210.

Subsequently, the redistribution layer 270, the power feeding electrode 285b, the ground electrodes 286b and 287b, the external connecting vias 283 and 284, and the insulating layer 230 are, as illustrated in FIG. 39, formed on an upper surface of the resin-molded layer 210.

Specifically, the power feeding electrode 285b is arranged on the upper end of the power feeding pad 202. The ground electrode 286b is arranged on the upper end of the grounding pad 203b. The ground electrode 287b is disposed on the upper end of the grounding pad 203a.

In other words, the power feeding electrode 285b is connected to the power feeding pad 202. The ground electrode 286b is connected to the grounding pad 203b. The ground electrode 287b is connected to the grounding pad 203a. The insulating layer 230 is arranged in the shape of a film which covers or occupies the upper surface of the resin-molded layer 210.

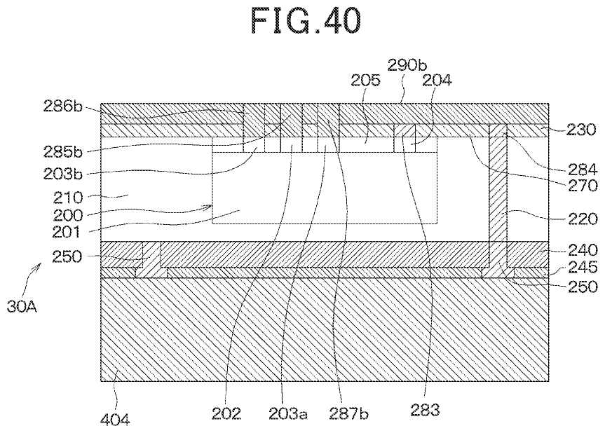

Subsequently, the connecting layer 290b is, as illustrated in FIG. 40, formed on the redistribution layer 270, the insulating layer 230, and the external connecting vias 283 and 284. The connecting layer 290b is shaped in the form of a film which covers over the redistribution layer 270 and the insulating layer 230. The power feeding electrode 285b and the ground electrodes 286b and 287b are embedded in the connecting layer 290b.

The connecting layer 290b is made from a thermosetting resin, such as Non-Conductive Film (NCF).

In the above away, the circuit substrate 30A is fabricated on the upper portion of the support wafer 404.

As apparent from the above discussion, the circuit substrate 30A includes the integrated circuit 200, the resin-molded layer 210, the resin-molded through-via 220, the insulating layers 230 and 240, the solder ball pads 250a and 250b, and the solder balls 260a and 260b.

The circuit substrate 30A is a semi-finished product, in other words, a workpiece which is fabricated in the process of manufacturing of the communication device 10 and includes the integrated circuit 200, while the circuit substrate assembly 30 is a part of the communication device 10 including the integrated circuit 200 after completed in the manufacturing process.

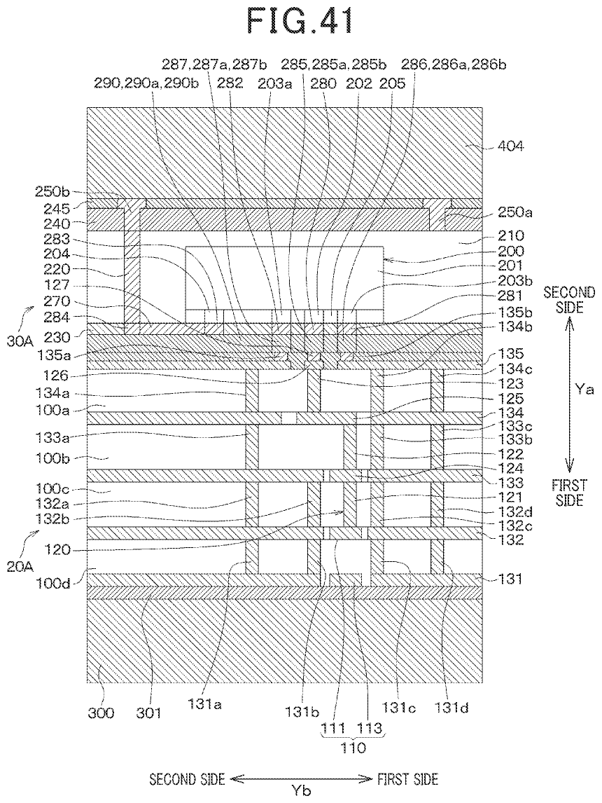

Subsequently, step S120 in FIG. 9 is performed. Specifically, the circuit substrate 30A is, as illustrated in FIG. 41, disposed on the antenna substrate 20A. The positional relation between the antenna substrate 20A and the circuit substrate 30A is adjusted to a required one. The connecting layers 290a and 290b are joined together using thermal compression bonding techniques to complete the connecting layer 290.

Specifically, the connecting layer 290 is produced by heating the power feeding electrodes 285a and 285b and the ground electrodes 286a, 286b, 287a, and 287b in a formic acid atmosphere until the temperature of the atmosphere reaches 250° C. and thermally pressure-bonding between the power feeding electrodes 285a and 285b, between the ground electrodes 286a and 286b, and between the ground electrodes 287a and 187b.

More specifically, the power feeding electrodes 285a and 285b are diffusion-bonded together with oxide films of the power feeding electrodes 285a and 285b reduced by the formic acid, thereby completing the power feeding electrode 285. This establishes connection of the power feeding pad 202 of the integrated circuit 200 and the connecting flanged layer 126 of the power feeding path 120 through the external connecting via 280 and the power feeding electrodes 127 and 285. In other words, the power feeding pad 202 of the integrated circuit 200 and the connecting flanged layer 126 of the power feeding path 120 are thermally pressure-bonded together by the power feeding electrode 285.

The power feeding electrode 285, therefore, serves as an electrical conductor used to connect the power feeding pad 202 and the connecting flanged layer 126 of the power feeding path 120 together. The electrical conductor is made from a conductive material containing copper.

The ground electrodes 287a and 287b are diffusion-bonded together with oxide films of the ground electrodes 287a and 287b reduced by the formic acid, thereby completing the ground electrode 287.

Consequently, the connection of the grounding pad 203a and the ground layer 135 is achieved through the external connecting via 282 and the ground electrodes 287 and 135a. In other words, the grounding pad 203a and the ground layer 135 are thermally pressure-bonded together.

Similarly, the ground electrodes 286a and 286b are diffusion-bonded together with oxide films of the ground electrodes 286a and 286b reduced by the formic acid, thereby completing the ground electrode 286. The connection of the grounding pad 203b and the ground layer 135 is, therefore, achieved through the external connecting via 281 and the ground electrodes 286 and 135b. In other words, the grounding pad 203b and the ground layer 135 are thermally pressure-bonded together.

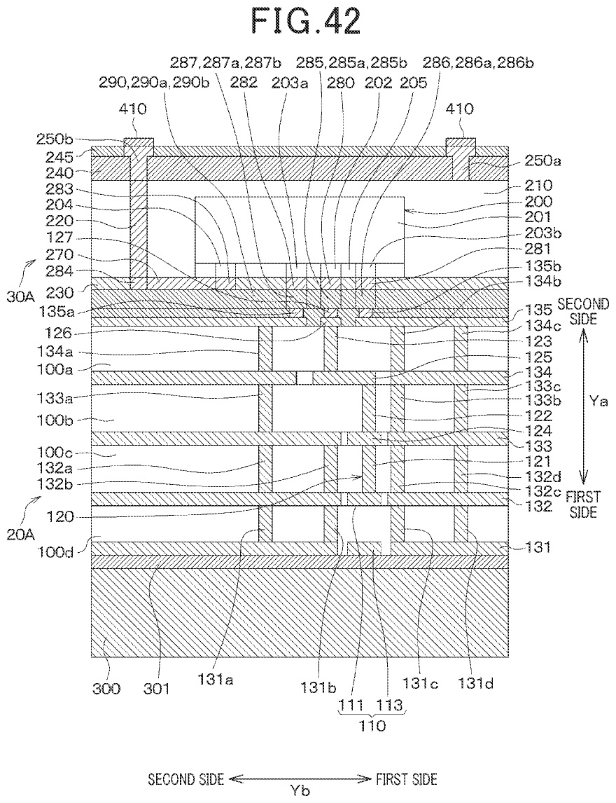

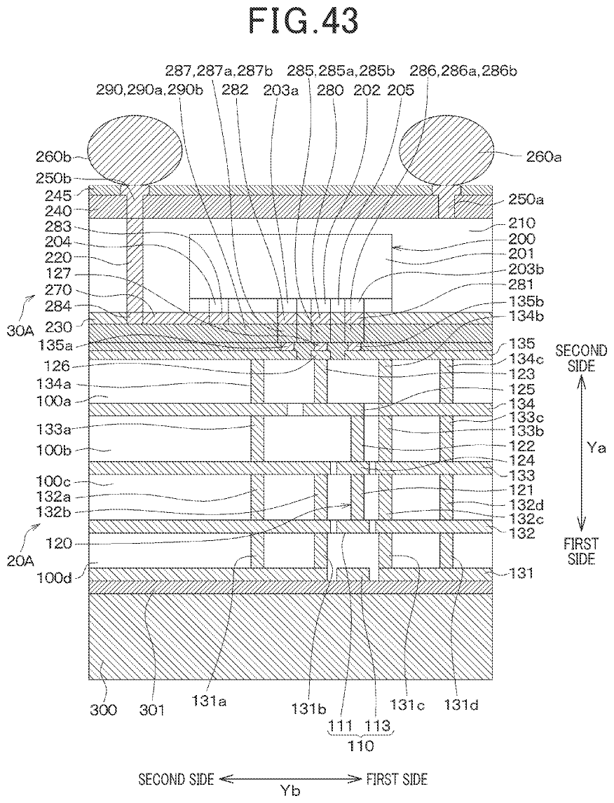

Afterwards, the support wafer 404 is, as demonstrated in FIGS. 42 and 43, removed from the integrated circuit 200. The fluxes 410 are transferred to upper ends of the solder ball pads 250 to form the solder ball pads 250. Subsequently, the supporting wafer 300 and the temporary bonding layer 301 are removed from the antenna substrate 20A. This completes the communication device 10.

The operation of the communication device 10 will be described below.

The arithmetic circuit 200a outputs a transmit data signal to the digital-to-analog converter 200d. The digital-to-analog converter 200d changes the transmit data signal into an analog signal. The modulation circuit 200e modulates an output from the digital-to-analog converter 200d using a carrier wave and outputs such a modulated signal to the antenna 110 through the power feeding path 120. The antenna 110 then emits the modulated signal conveyed with an electromagnetic wave.

Specifically, the antenna 110 propagates the modulated signal in the form of the electromagnetic wave. In the antenna 110, the electromagnetic wave is guided by the waveguide layer 113 so that it is propagated mainly toward the first side in the thickness direction Ya.

The antenna 110 receives a signal conveyed by an electromagnetic wave. The antenna 110 then sends the received signal to the demodulating circuit 200c through the power feeding path 120.

The demodulating circuit 200c demodulates the received signal and outputs it to the analog-to-digital converter 200b in the form of a demodulated signal. The analog-to-digital converter 200b changes the demodulated signal from an analog to a digital form. The arithmetic circuit 200a is responsive to the output from the analog-to-digital converter 200b to execute given tasks.

The modulated signal or the electromagnetic wave of the received signal appears in the power feeding vias 121, 122, and 123, the connecting flanged layers 124 and 126, the connecting elongated-plate layer 125, and the power feeding electrode 127 of the power feeding path 120.

The electromagnetic shield 130 is made from a conductive material containing copper and connected to ground of the integrated circuit 200. The electromagnetic shield 130 works to minimize the propagation of the electromagnetic wave, as appearing in the power feeding path 120, outside the region 130A which will be described later in detail.

Specifically, the ground layers 132 and 131 serve to block the propagation of the electromagnetic wave, as appearing in the power feeding path 120, toward the first side in the thickness direction Ya. The ground layers 133 and 134 serve to block the propagation of the electromagnetic wave, as appearing in the power feeding path 120, toward the first and second sides in the width direction Yb and the first and second sides in the depth direction Yc. The ground layer 135 serves to block the propagation of the electromagnetic wave, as appearing in the power feeding path 120, toward the second side in the thickness direction Ya.

The ground vias 131a, 131b, 132a, 132b, 133a, and 134a serve to block the propagation of the electromagnetic wave, as appearing in the power feeding path 120, toward the second side in the width direction Yb. The ground vias 131c, 131d, 132c, 132d, 133b, 133c, 134b, and 134c serve to block the propagation of the electromagnetic wave, as appearing in the power feeding path 120, toward the first side in the width direction Yb.

The electromagnetic shield 130 works to prevent the electromagnetic wave, as propagated from outside the region 130A, from being received the power feeding path 120.

Specifically, the ground layers 132 and 131 work to block the propagation of the electromagnetic wave, as coming from the first side in the thickness direction Ya, to the power feeding path 120. Additionally, the ground layers 133 and 134 work to prevent the electromagnetic wave, as directed from the first or the second side in the width direction Yb and also from the first or second side in the depth direction Yc, from being received by the power feeding path 120.

The ground layer 135 works to block the propagation of the electromagnetic wave, as coming from the second side in the thickness direction Ya, to the power feeding path 120.

The ground vias 131a, 131b, 132a, 132b, 133a, and 134a work to prevent the electromagnetic wave, as coming from the second side in the width direction Yb, from being received by the power feeding path 120.

The ground vias 131c, 131d, 132c, 132d, 133b, 133c, 134b, and 134c work to prevent the electromagnetic wave, as coming from the first side in the width direction Yb, from being received by the power feeding path 120.

The region 130A, as referred to herein, is a region defined between a combination of the ground vias 131a, 132a, 133a, and 134a and a combination of the ground vias 131d, 132d, 133c, and 134c. The region 130A is also surrounded by the ground layers 131 and 135.

As apparent from the above discussion, the production method of the communication device 10 includes a step of forming the antenna substrate 20A and a step of forming the circuit substrate 30A independently from the antenna substrate 20A. The production method of the communication device 10 also includes a step of joining the antenna substrate 20A and the circuit substrate 30A together the power feeding pad 202 connected with the power feeding path 120. In other words, the antenna substrate 20A is joined to the circuit substrate 30A simultaneously with the connection of the power feeding pad 202 and the power feeding path 120.

The antenna substrate 20A is equipped with the dielectric layers 100a, 100b, 100c, and 100d which are of a plate-shape made from an electrically insulating material and the antenna 110 disposed over the dielectric layers 100a, 100b, 100c, and 100d. The antenna substrate 20A has the power feeding path 120 which are disposed in the dielectric layers 100a, 100b, 100c, and 100d in electrical connection with the antenna 110.

The circuit substrate 30A is equipped with the resin-molded layer 210 and the integrated circuit 200. The resin-molded layer 210 is of a plate-shape made from an electrically insulating material. The integrated circuit 200 is equipped with the power feeding pad 202 which is mounted in the resin-molded layer 210 and connects with the antenna 110 through the power feeding path 120. The integrated circuit 200 works as a communication integrated circuit which outputs a signal from the antenna 110 or receives a signal through the antenna 110.

In the above way, the circuit substrate 30A and the antenna substrate 20A are formed in discrete production steps. This results in improved production yield of the circuit substrate 30A and the antenna substrate 20A as compared with when they are produced in a single step.

This embodiment offers the following beneficial advantages a), b), c), d), e), f), g), h), i), and j).
a) The power feeding pad 202 and the power feeding path 120 of the integrated circuit 200 are made from a conductive material containing copper. The connection of the power feeding pad 202 and the power feeding path 120 are thermally pressure-bonded using the power feeding electrode 285 made from a conductive material containing copper.

The above thermal pressure-bonding results in a decrease in electrical resistance between the power feeding pad 202 and the power feeding path 120 as compared with when the power feeding pad 202 and the power feeding path 120 are connected together using a conductive material other than copper (e.g., solder material).
b) The step of producing the antenna substrate 20A includes a step of forming the electromagnetic shield 130 which is made from a conductive material containing copper and surrounds the power feeding path 120 from the first and second sides in the width direction Yb in connection to ground.

The electromagnetic shield 130 works to block the leakage of an electromagnetic wave, as appearing in the power feeding path 120, outside the region 130A. The electromagnetic shield 130 also works to block the propagation of an electromagnetic wave, as coming from outside the region 130A, to the power feeding path 120.

It is, therefore, possible to prevent the electromagnetic wave from being propagated from the power feeding path 120 to the antenna 110 in a direction other than the thickness direction Ya toward the first side. It is also possible to prevent the power feeding path 120 from receiving the electromagnetic wave which travels to the antenna 110 in a direction other than the thickness direction Ya toward the first side.
c) The step of producing the power feeding path 120 includes a step of forming the connecting elongated-plate layer 125 extending in the depth direction Yc.

The step of producing the electromagnetic shield 130 includes a step of forming the ground layer 133 which is located closer to the first side than the connecting elongated-plate layer 125 is in the thickness direction Ya and shaped in the form of a film spreading both in the width direction Yb and in the depth direction Yc.

The step of producing the electromagnetic shield 130 includes a step of forming the ground layer 135 which is located closer to the second side than the connecting elongated-plate layer 125 is in the thickness direction Ya and shaped in the form of a film extending both in the width direction Yb and in the depth direction Yc.

The electromagnetic shield 130, as described above, includes the ground layer 133 which arranged closer to the first side than the connecting elongated-plate layer 125 is in the thickness direction Ya and shaped in the form of a film extending both in the width direction Yb and in the depth direction Yc.

The ground layer 133, therefore, functions to block the propagation of an electromagnetic wave, as appearing in the connecting elongated-plate layer 125, to the first side in the thickness direction Ya therethrough. The ground layer 133 also serves to block the propagation of an electromagnetic wave, as traveling from the first side to the second side in the thickness direction Ya, to the connecting elongated-plate layer 125.

The electromagnetic shield 130, as described above, also includes the ground layer 135 which is arranged closer to the second side than the connecting elongated-plate layer 125 is in the thickness direction Ya and shaped in the form of a film extending both in the width direction Yb and in the depth direction Yc.

The ground layer 135, therefore, functions to block the propagation of an electromagnetic wave, as appearing in the connecting elongated-plate layer 125, to the second side in the thickness direction Ya therethrough. The ground layer 135 also serves to block the propagation of an electromagnetic wave, as traveling from the second side to the first side in the thickness direction Ya, to the connecting elongated-plate layer 125.
d) The step of producing the electromagnetic shield 130 includes a step of forming the ground layer 134 surrounding the connecting elongated-plate layer 125 in the width direction Yb and the depth direction Yc.

The ground layer 134, therefore, functions to block the propagation of an electromagnetic wave, as appearing in the connecting elongated-plate layer 125, therethrough in the width direction Yb and the depth direction Yc. The ground layer 134 also functions to block the propagation of an electromagnetic wave, as traveling from the width direction Yb or the depth direction Yc, to the connecting elongated-plate layer 125.
e) The step of producing the power feeding path 120 includes a step of forming the power feeding via 122 which is arranged closer to the first side than the connecting elongated-plate layer 125 is in the thickness direction Ya and connects with the connecting elongated-plate layer 125.

The step of producing the electromagnetic shield 130 includes a step of forming the ground vias 133b and 133c which are located closer to the first side than the power feeding via 122 is in the width direction Yb and arranged in the depth direction Yc.

The step of producing the electromagnetic shield 130 includes a step of forming the ground vias 134a which are located closer to the second side than the power feeding via 122 is in the width direction Yb and arranged adjacent each other in the depth direction Yc. The ground vias 133a, 133b, and 133c, therefore, work to block the propagation of an electromagnetic wave, as appearing in the power feeding via 122, outside the region 130A. The region 130A is defined as a region lying among the ground vias 133a and the ground vias 133b and 133c.

The ground vias 133a and the ground vias 133b and 133c, therefore, work to block the propagation of an electromagnetic wave, as coming from outside the region 130A, to the power feeding via 122 located inside the region 130A.
f) The step of producing the electromagnetic shield 130 includes a step of forming the ground vias 133a, 133b, and 133c which extend through the dielectric layer 100b in the thickness direction Ya. The dielectric layer 100b, therefor, function to enhance the electrical insulation between the power feeding via 122 and the ground vias 133a, 133b, and 133c.
g) The step of producing the power feeding path 120 includes a step of forming the power feeding via 122 which is located closer to the first side than the connecting elongated-plate layer 125 is in the thickness direction Ya and shaped in the form of a cylinder centered at the axial line C1 extending in the thickness direction Ya.

The step of producing the power feeding path 120 includes a step of forming the connecting flanged layer 124 which is located closer to the first side than the power feeding via 122 is in the thickness direction Ya, connects with the power feeding via 122, and shaped in the form of a disc centered at the axis line C1.

The step of producing the power feeding path 120 includes a step of forming the power feeding via 124 which is located closer to the first side than the connecting flanged layer 124 in the thickness direction Ya, connects with the connecting flanged layer 124, and shaped in the form of a cylinder centered at the axis line C1. The connecting flanged layer 124 is centered at the axis line C1 and shaped to spread or extend to outside the power feeding vias 121 and 122 in a radial direction perpendicular to the axis line C1.

The above layout of the connecting flanged layer 124, therefore, ensures the stability in connection of the power feeding vias 121 and 122 even when the power feeding vias 121 and 122 are undesirably misaligned in a direction perpendicular to the thickness direction Ya.
h) The step of producing the antenna substrate 20A includes a step of forming the power feeding via 121 and the ground vias 132a, 132b, 132c, and 132d and a step of forming the dielectric layer 100c (which will also be referred to as a first insulating substrate) made from an electrically insulating material.

Specifically, the electrically insulating material is first disposed to fully cover the power feeding via 121 and the ground vias 132a, 132b, 132c, and 132d. The power feeding via 121 and the ground vias 132a, 132b, 132c, and 132d are arranged to have ends which face the second side in the thickness direction Ya and are exposed outside the electrically insulating material.

Additionally, the end of the electrically insulating material which faces the second side in the thickness direction Ya and the ends of the power feeding via 121 and the ground vias 132a, 132b, 132c, and 132d which face the second side in the thickness direction Ya are all shaped to be flat, thereby completing the dielectric layer 100c.

The step of producing the antenna substrate 20A includes a step of forming the connecting flanged layer 124 serving as a second power feeding path. The connecting flanged layer 124 is located closer to the second side than the dielectric layer 100c is in the thickness direction Ya, connects with the power feeding via 121, and is shaped in the form of a film which is centered at the axis line C1 and extends or spread both in the width direction Yb and in the depth direction Yc. The step of producing the antenna substrate 20A includes a step of forming the ground layer 133 working as a third electromagnetically shielding conductor. The antenna substrate 20A is located closer to the second side than the dielectric layer 100c is in the thickness direction Ya and connects with the ground vias 132a, 132b, 132c, and 132d. The ground layer 133 is shaped in the form of a film spreading both in the width direction Yb and in the depth direction Yc to surround the connecting flanged layer 124.

When vias and a dielectric layer are formed in a conventional way to have upper ends thereof which do not lie flush with each other, it will cause the upper ends of the vias which face the second side in the thickness direction Ya to be stepped or unleveled in the thickness direction Ya. In order to alleviate such a drawback, two or more vias are usually designed not to be laid vertically on one another. The communication device 10 in this embodiment has two vias (i.e., the power feeding vias 121 and 122) which constitute a high-frequency circuit in which a high-frequency electrical current flows. If the vias undesirably have uneven portions or ends, it may result in radiation of an unwanted electromagnetic noise which usually leads to a decrease in performance of the antenna 110.

In order to eliminate the above problem, the production method of the communication device 10 includes a step of simultaneously shaping ends of the power feeding via 121 and the ground vias 132a, 132b, 132c, and 132d which face the second side in the thickness direction Ya and an upper portion or surface of the dielectric layer 100c which face the second side in the thickness direction Ya to be flat. This enables the longitudinal center lines of the power feeding vias 121 and 122 to be aligned with each other in the thickness direction Ya, thereby facilitating the ease with which the power feeding vias 121 and 122 to be connected to the connecting flanged layer 124. In other words, it is possible for the production method of the communication device 10 to eliminate the risk that the power feeding vias 121 and 122 may be shaped to be misaligned with each other in the thickness direction Ya. This avoids the radiation of an electromagnetic noise and ensures a desired degree of performance of the antenna 110.

A variation in thickness of the dielectric layer 100c usually adversely impinges on the antenna gain in the communication device 10. In order to alleviate such a problem, the production method in this embodiment, as described above, forms the electrically insulating layer and then shapes it to have a flat surface to complete the dielectric layer 100c. This facilitates the adjustment of the thickness of the dielectric layer 100c, in other words, the minimization of the variation in thickness of the dielectric layer 100c, thereby eliminating the risk that the variation in thickness of the dielectric layer 100c in the production of the communication device 10 may adversely affect the antenna gain in the communication device 10.

The production method in this embodiment, as described above, also shapes the surfaces of the power feeding via 121 and the ground vias 132a, 132b, 132c, and 132d which face the second side in the thickness direction Ya and the surface of the dielectric layer 100c which faces the second side in the thickness direction Ya to be flat. This facilitates the shaping of the surfaces of the connecting flanged layer 124 and the ground layer 133 to be flat along the surface of the dielectric layer 100c which faces the second side in the thickness direction Ya, thereby minimizing a risk that the configuration of the connecting flanged layer 124 and the ground layer 133 may adversely affect the antenna performance in the communication device 10. In the above way, the production method in this embodiment is capable of fabricating the antenna 110 which is excellent in performance thereof.

The ground vias 132a, 132b, 132c, and 132d, as described above, work to minimize the leakage of electromagnetic wave, as appearing in the power feeding via 121, outside the region 130A. The ground vias 132a, 132b, 132c, and 132d also work to minimize the propagation of electromagnetic wave, as coming from outside the region 130A, to the power feeding via 121. The region 130A is a region surrounded by the ground vias 132a and 132b and the ground vias 132c and 132d.

The ground layer 133 blocks the emission of electromagnetic wave from the connecting flanged layer 124 both in the width direction Yb and in the depth direction Yc. The ground layer 133 also prevents an electromagnetic wave, as propagating from the width direction Yb or the depth direction Yc, from being received by the connecting flanged layer 124.
i) The step of producing the antenna substrate 20A includes a step of forming the power feeding via 122 used as a first power feeding path and the ground vias 133b, 133c, and 133a which are located on the first side and the second side in a first crossing direction (i.e., the width direction Yb) which transverses the length of the power feeding via 122.

The power feeding via 122 is made from a conductive material containing copper and designed as the first power feeding path which is of a cylindrical shape centered at the axis line C1 extending in the thickness direction Ya. The ground vias 133b and 133c serve as a first electromagnetically shielding conductor which is made from a conductive material containing copper and extends in the thickness direction Ya. The ground vias 133a serve as a second electromagnetically shielding conductor which is made from a conductive material containing copper and extends in the thickness direction Ya.

In the step of forming the antenna substrate 20A, an electrically insulating material is, as described above, disposed to fully cover the power feeding via 122 and the ground vias 133a, 133b, and 133c.

The above step also places the power feeding via 122 and the ground vias 133a, 133b, and 133c to have surfaces which face the second side in the thickness direction Ya and are exposed to the outside.

The above step also includes a step of shaping the surface of the electrically insulating material and the end surfaces of the power feeding via 122 and the ground vias 133a, 133b, and 133c which all face the second side in the thickness direction Ya to be flat or lie flush with each other, thereby completing the dielectric layer 100b as a first insulating substrate.

The step of producing the antenna substrate 20A includes a step of forming the connecting elongated-plate layer 125 working as a second power feeding path which is disposed on the surface of the dielectric layer 100b which faces the second side in the thickness direction Ya. The second power feeding path connects with the power feeding via 122 and, as clearly illustrated in FIG. 6, extends in the depth direction Yc.

The step of producing the antenna substrate 20A includes a step of forming the ground layer 134 serving as a third electromagnetic shielding conductor which is arranged on the surface of the dielectric layer 100b which faces in the thickness direction Ya and connects with the ground vias 133a, 133b, and 133c. The ground layer 134 is shaped in the form of a film which spreads both in the width direction Yb and in the depth direction Yc to surround the connecting elongated-plate layer 125.

The above production steps enable the end surfaces of the power feeding via 122 and the ground vias 133a, 133b, and 133c which face the second side in the thickness direction Ya and the surface of the dielectric layer 100b which face the second side in the thickness direction Ya to be flat or lie flush with each other. This eliminates a risk that a variation in thickness of the dielectric layer 100b may adversely affect the antenna gain in the communication device 10.

Further, the connecting elongated-plate layer 125 and the ground layer 134 are simultaneously shaped to be flat along the surface of the dielectric layer 100b which faces the second side in the thickness direction Ya in the same step. This also eliminates a risk that the configurations of the connecting elongated-plate layer 125 and the ground layer 134 may adversely affect the antenna performance in the communication device 10. It is also possible to shape the power feeding via 123 to extend in the thickness direction Ya in a simplified manner, thereby facilitating the ease with which the power feeding vias 123 and 122 are connected together through the connecting elongated-plate layer 125.

The ground vias 133a, 133b, and 133c work to minimize the leakage of electromagnetic wave, as appearing in the power feeding via 122, outside the region 130A. The ground vias 133a, 133b, and 133c also work to block the propagation of electromagnetic wave, as coming from outside the region 130A, to the power feeding via 122. The region 130A is a region surrounded by the ground vias 133a and the ground vias 133b and 133c.

The ground layer 134 blocks the emission of electromagnetic wave from the connecting elongated-plate layer 125 both in the width direction Yb and in the depth direction Yc. The ground layer 134 also prevents an electromagnetic wave, as coming from the width direction Yb or the depth direction Yc, from being received by the connecting elongated-plate layer 125.
j) The step of producing the antenna substrate 20A includes a step of forming the ground vias 131c and 131d serving as the first electromagnetically shielding conductor and the ground vias 131a and 131b serving as the second electromagnetically shielding conductor. The ground vias 131c and 131d and the ground vias 131a and 131b are each made from a conductive material containing copper. The ground vias 131c and 131d and the ground vias 131a and 131b are arranged in the width direction Yb and extend in the thickness direction Ya.

The step of producing the antenna substrate 20A includes a step of arranging an electrically insulating material to fully cover the ground vias 131a, 131b, 131c, and 131c. The ground vias 131a, 131b, 131c, and 131c are placed to have the ends which face the second side in the thickness direction Ya and are exposed outside the electrically insulating material.

In the above step, the end surfaces of the ground vias 131a, 131b, 131c, and 131c and the surface of the electrically insulating material which face the second side in the thickness direction Ya are shaped to be flat or lie flush with each other, thereby completing the dielectric layer 100d with the electrically insulating material. The dielectric layer 100d is designed as the first insulating substrate in the communication device 10

The step of producing the antenna substrate 20A includes a step of forming the antenna layer 111 working as an antenna. The antenna layer 111 is disposed on the surface of the dielectric layer 100d which faces the second side in the thickness direction Ya and is shaped in the form of a film spreading both in the width direction Yb and in the depth direction Yc. The antenna layer 111 is arranged closer to the second side than the ground vias 131c and 131d are in the width direction Yb and also closer to the first side than the ground vias 131a and 131b are in the width direction Yb.

The step of producing the antenna substrate 20A includes a step of forming the ground layer 132 which is located closer to the second side than the dielectric layer 100d is in the thickness direction Ya and connects with the ground vias 131a, 131b, 131c, and 131c. The ground layer 132 serves as a third electromagnetic shielding conductor and is shaped in the form of a film which spreads both in the width direction Yb and in the depth direction Yc to surround the antenna layer 111.

The above production steps facilitate the ease with which the end surfaces of the ground vias 131a, 131b, 131c, and 131c and the surface of the dielectric layer 100d which face the second side in the thickness direction Ya are shaped to be flat or lie flush with each other. This eliminates a risk that a variation in thickness of the dielectric layer 100d may adversely affect the antenna gain in the communication device 10.

Further, the ground layer 132 and the antenna layer 111 are simultaneously shaped to be flat along the surface of the dielectric layer 100b which faces the second side in the thickness direction Ya in the same step. This also eliminates a risk that the configurations of the ground layer 132 and the antenna layer 111 may adversely affect the antenna performance in the communication device 10. It is also possible to shape the power feeding via 121 to extend in the thickness direction Ya in a simplified manner, thereby facilitating the ease with which the power feeding via 121 is connected to the antenna layer 111.

The ground vias 131c and 131d work to block the propagation of electromagnetic wave from the antenna layer 111 to the first side in the width direction Yb. The ground vias 131c and 131d also prevent the electromagnetic wave, as propagating from the first side in the width direction Yb, from being received by the antenna layer 111.

The ground vias 131a and 131b also block the propagation of electromagnetic wave from the antenna layer 111 to the second side in the width direction Yb. The ground vias 131a and 131b also prevents the electromagnetic wave, as propagating from the second side in the width direction Yb, from being received by the antenna layer 111.

The ground layer 132 works to block the propagation of electromagnetic wave from the antenna layer 111 both in the width direction Yb and in the depth direction Yc. The ground layer 132 also prevents the electromagnetic wave, as traveling from the width direction Yb or the depth direction Yc, from being received by the antenna layer 111.

### Second Embodiment

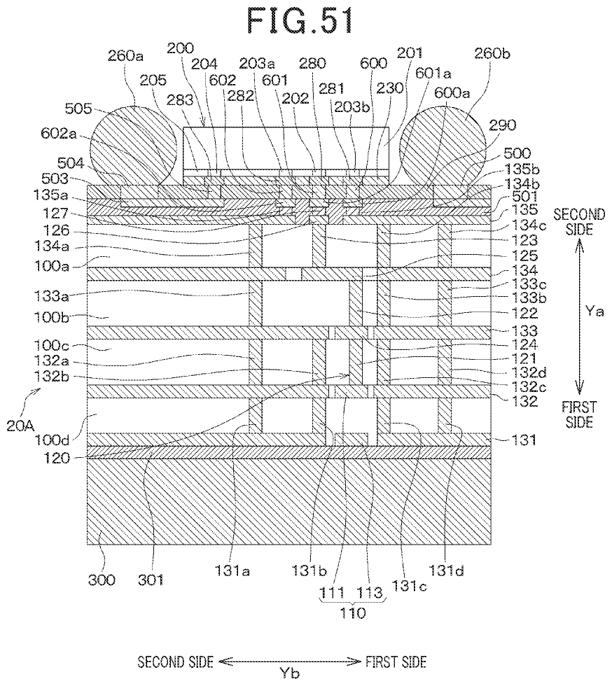

The first embodiment has referred to the securement of the integrated circuit 200 to the circuit substrate 30A which is achieved by joining the antenna substrate 20A and the circuit substrate 30A together. The second embodiment, instead, achieves the joining of the integrated circuit 200 to the circuit substrate 30A with the integrated circuit 200 born by the supporting wafer 300. The second embodiment will be described below with reference to FIGS. 9 and 44 to 51.

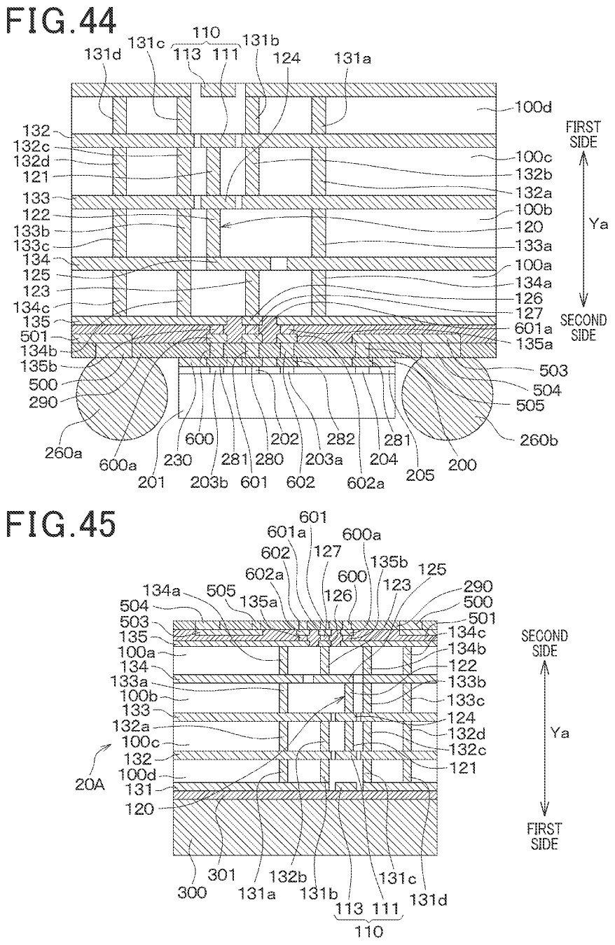

The communication device 10 in the second embodiment, as illustrated in FIG. 44, includes the solder ball pads 500 and 504, the signal electrode 505, the redistribution layers 501 and 503, and the solder balls 260a and 260b in addition to the parts of the communication device 10 in the first embodiment.

The communication device 10 in the second embodiment also includes the connecting layer 290, the power feeding electrode 601, the ground electrodes 600 and 602, and the connecting electrodes 601a, 600a, and 602a.

The power feeding electrode 601 is arranged closer to the second side than the power feeding electrode 127 is in the thickness direction Ya. The power feeding electrode 601 connects with the power feeding electrode 127 through the connecting electrode 601a.

The ground electrode 600 is located closer to the second side than the ground electrode 135b is in the thickness direction Ya. The ground electrode 600 connects with the ground electrode 135b through the connecting electrode 600a.

The ground electrode 602 is arranged closer to the second side than the ground electrode 135a is in the thickness direction Ya. The ground electrode 602 connects with the ground electrode 135a through the connecting electrode 602a.

The ground electrodes 600 and 602 and the connecting electrodes 600a, 601a, and 602a are made from a conductive material containing copper.

The solder ball pads 500 and 504 are disposed to extend through the connecting layer 290 in the thickness direction Ya. The redistribution layer 503 connects between the solder ball pad 504 and the signal electrode 505. The solder ball pad 500 connects with the redistribution layer 501.

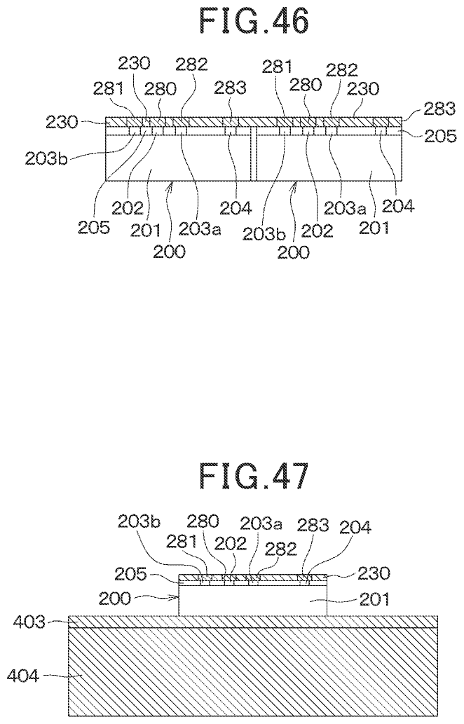

The communication device 10 in the second embodiment is, as illustrated in FIG. 46, equipped with a plurality of integrated circuits 200 each of which, like in the first embodiment, includes the semiconductor device 201, the power feeding pad 202, the grounding pads 203a and 203b, the signaling pad 204, and the protective film 205.

Each of the integrated circuits 200 also includes the insulating layer 230 and the external connecting vias 280, 281, 282, and 283.

The insulating layer 230 is shaped in the form of a film which covers the power feeding pad 202, the grounding pads 203a and 203b, the signaling pad 204, and the protective film 205 from the first side in the thickness direction Ya.

The external connecting via 280 is disposed to extend through the insulating layer 230 in the thickness direction Ya. The external connecting via 280 has an end which faces the second side in the thickness direction Ya and connects with the power feeding pad 202 of the integrated circuit 200.

The external connecting via 281 extends through the insulating layer 230 in the thickness direction Ya. The external connecting via 281 has an end which faces the second side in the thickness direction Ya and connects with the grounding pad 203b of the integrated circuit 200.

The external connecting via 282 extends through the insulating layer 230 in the thickness direction Ya. The external connecting via 282 has an end which faces the second side in the thickness direction Ya and connects with the grounding pad 203a of the integrated circuit 200.

The external connecting via 283 extends through the insulating layer 230 in the thickness direction Ya. The external connecting via 283 has an end which faces the second side in the thickness direction Ya and connects with the signaling pad 204 of the integrated circuit 200.

The external connecting vias 280, 281, 282, and 283 are each made from a conductive material containing copper.

A production method of the communication device 10 in the second embodiment will be described below with reference to FIGS. 9, and 44 to 53 which are sectional views of the communication device 10 in production steps.

Referring back to FIG. 9, in step S100 (i.e., the first production step), the antenna substrate 20A is, as illustrated in FIG. 45, formed.

Subsequently, in step S110 (i.e., the second production step), a plurality of integrated circuits 200 are, as illustrated in FIG. 46, formed.

The integrated circuits 200 are then separated from each other. One of the integrated circuits 200 is mounted on the upper surface of the support wafer 404. Specifically, one of the integrated circuits 200 is, as clearly illustrated in FIG. 47, retained on the upper surface of the support wafer 404.

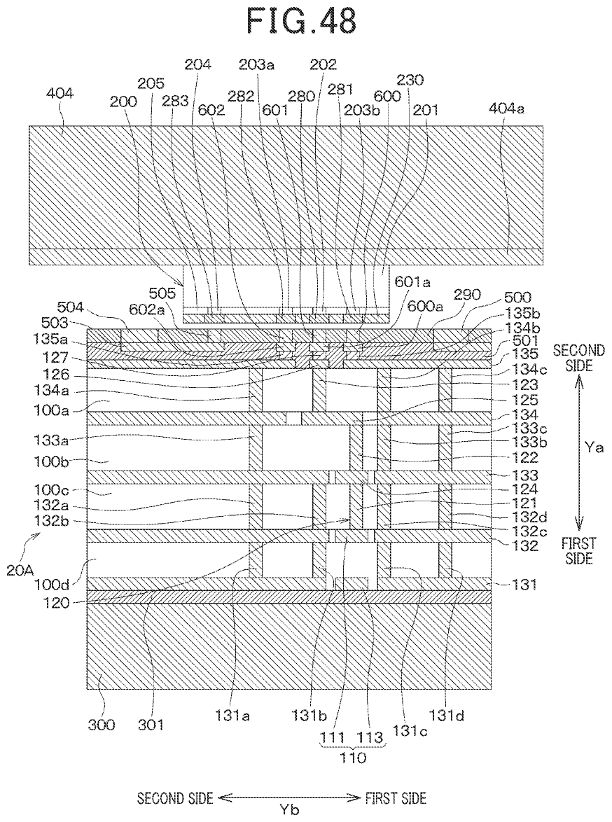

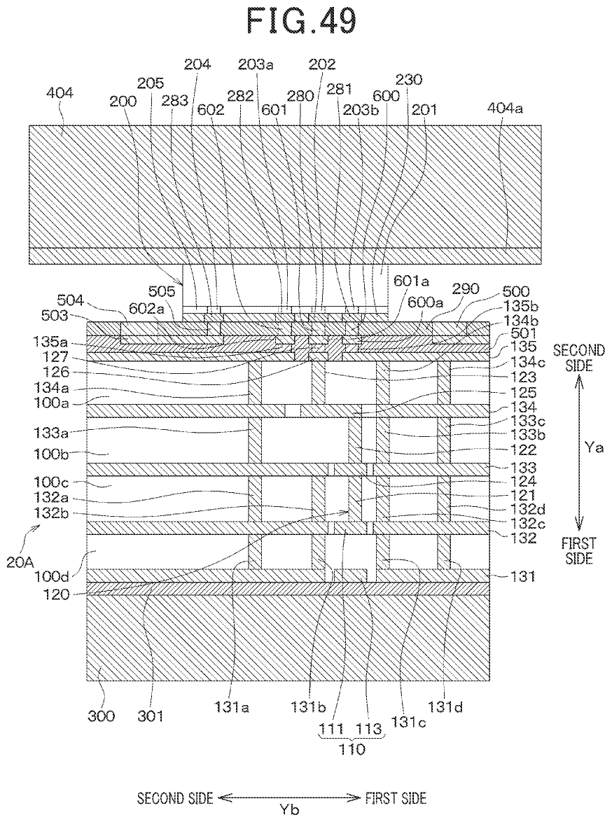

Subsequently, the one of the integrated circuits 200 is, as clearly illustrated in FIGS. 48 and 49, mounted on the antenna substrate 20A. The positional relation between the antenna substrate 20A and the circuit substrate 30A is, then, adjusted to a desired relation. The connecting layer 290 and the insulating layer 230 are thermally pressure-bonded together. Each of the connecting layer 290 and the insulating layer 230 is made from thermosetting resin, such as non-conductive film (NCF).

The external connecting vias 281, 280, 282, and 283, the ground electrodes 600 and 602, the power feeding electrode 601, and the signal electrode 505 are heated in a formic acid atmosphere until the temperature of the atmosphere reaches 250° C.

The external connecting via 281 and the ground electrode 600 are diffusion-bonded together with oxide films of the external connecting via 281 and the ground electrode 286 reduced by the formic acid. The grounding pad 203b and the ground electrode 135b are, therefore, joined together through the external connecting via 281, the ground electrode 600, and the connecting electrode 600a.

In other words, the grounding pad 203b and the ground electrode 135b are thermally pressure-bonded together. The external connecting via 280 and the power feeding electrode 601 are diffusion-bonded together with the oxide films of the external connecting via 280 and the power feeding electrode 601 reduced by the formic acid.

The power feeding pad 202 of the integrated circuit 200 and the connecting flanged layer 126 of the power feeding path 120 are, therefore, connected together through the external connecting via 280, the power feeding electrode 127, the power feeding electrode 601, and the connecting electrode 601a. In other words, the power feeding pad 202 of the integrated circuit 200 and the connecting flanged layer 126 of the power feeding path 120 are thermally pressure-bonded together.

The external connecting via 282 and the ground electrode 602 are diffusion-bonded together with oxide films of the external connecting via 282 and the ground electrode 602 reduced by formic acid. The grounding pad 203a of the integrated circuit 200 and the ground electrode 135a are, therefore, thermally pressure-bonded together through the external connecting via 282, the ground electrode 602, and the connecting electrode 602a.

The external connecting via 283 and the signal electrode 505 are diffusion-bonded together with oxide films of the external connecting via 283 and the signal electrode 505 reduced by formic acid. The external connecting via 283 and the solder ball pad 504 are, therefore, connected together through the signal electrode 505 and the signal electrode 505.

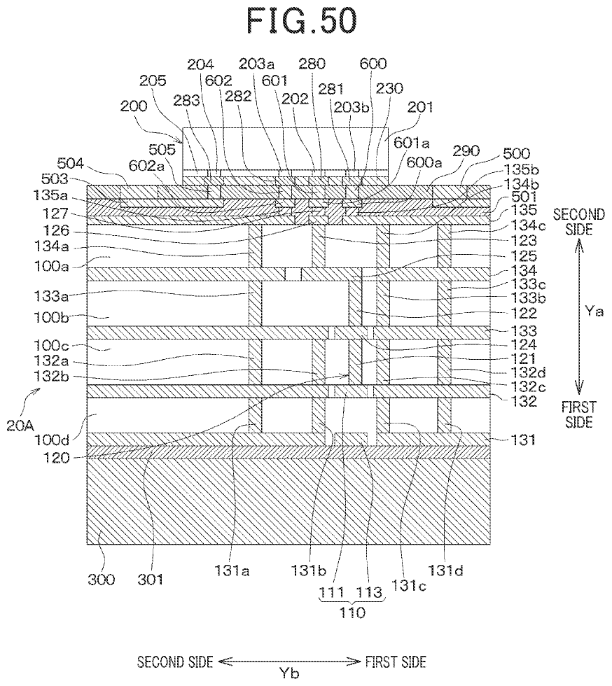

Afterwards, the support wafer 404 is, as demonstrated in FIG. 50, removed from the integrated circuit 200. The solder ball 260a is formed on the solder ball pad 504. Similarly, the solder ball 260b is formed on the solder ball pad 500. Subsequently, the supporting wafer 300 and the temporary bonding layer 301 are removed from the antenna substrate 20A.

In the above way, the integrated circuit 200 and the antenna substrate 20A are connected together, thereby completing the communication device 10.

As apparent from the above discussion, the production method of the communication device 10 in the second embodiment includes a step of forming the antenna substrate 20A and a step of forming the integrated circuit 200 independently from the antenna substrate 20A. The production method of the communication device 10 also includes a step of joining the antenna substrate 20A and the integrated circuit 200 together with the power feeding pad 202 and the power feeding path 120 joined together.

As apparent from the above discussion, the production method in this embodiment executes discrete steps: a first step to form the circuit substrate 30A and a second step to fabricate the integrated circuit 200. This improves the production yield of the circuit substrate 30A and the integrated circuit 200 as compared with when they are produced in a single step.

The power feeding pad 202 of the integrated circuit 200 and the connecting flanged layer 126 of the power feeding path 120 are thermally pressure-bonded together through the external connecting via 280 and the power feeding electrode 601. This, like in the first embodiment, results in a decreased electrical resistance between the power feeding pad 202 and the power feeding path 120.

The external connecting via 280 and the power feeding electrode 601 in this embodiment serve as conductive members for use in connecting the power feeding pad 202 and the connecting flanged layer 126 of the power feeding path 120. The conductive members are each made from a conductive material containing copper.

### Third Embodiment

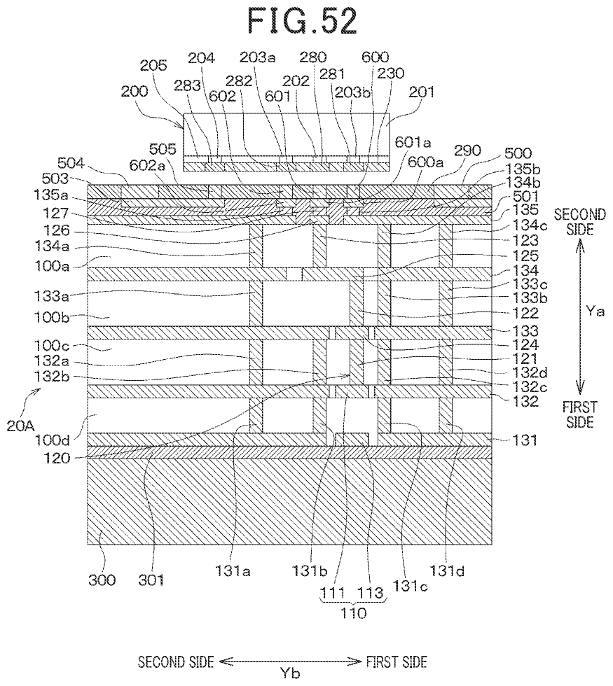

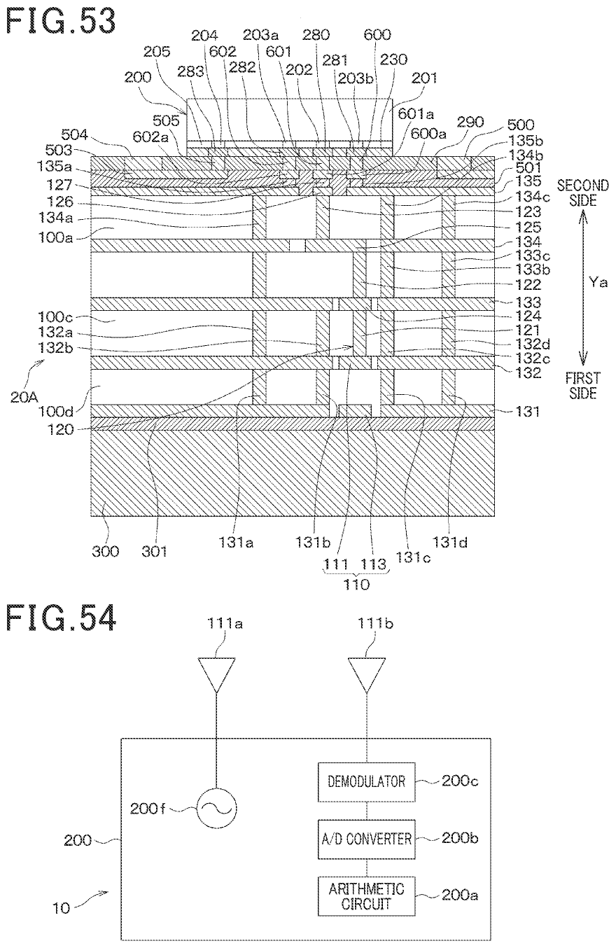

While the second embodiment has referred to the production method of the communication device 10 in which the integrated circuit 200 is joined to the circuit substrate 30A with the integrated circuit 200 retained by the supporting wafer 300, the third embodiment joints the integrated circuit 200 to the circuit substrate 30A separately from the supporting wafer 300. The third embodiment will be described below with reference to FIGS. 52 and 53.

The communication device 10 in the third embodiment is substantially identical in structure with that in the second embodiment.

The production method of the communication device 10 in the third embodiment includes two discrete steps: a first step of forming the antenna substrate 20A and a second step of forming the integrated circuit 200 separately from the antenna substrate 20A. The production method also includes a step of joining the antenna substrate 20A and the integrated circuit 200 together with the power feeding pad 202 and the power feeding path 120 connected together, but without the integrated circuit 200 born by the supporting wafer 300.

In the same manner as in the first embodiment, the power feeding pad 202 of the integrated circuit 200 and the connecting flanged layer 126 of the power feeding path 120 are thermally pressure-bonded together. The grounding pad 203b and the ground electrode 135b are thermally pressure-bonded together. The grounding pad 203a of the integrated circuit 200 and the ground electrode 135a are thermally pressure-bonded together.

The production method in this embodiment, like in the first embodiment, improves the production yield of the circuit substrate 30A and the integrated circuit 200 as compared with when they are produced in a single step.

### Other Embodiments

The above first, second, and third embodiments have referred to the communication device 10 designed as a communication system using millimeter waves, but however, the communication device 10 may alternatively be modified as discussed below.
a) The communication device 10 may be designed to use electromagnetic waves, such as microwaves.
b) The communication device 10 may be designed as a radio communication device for a mobile phone, a portable information terminal, or a wireless local area network (LAN).

The first, second, and third embodiments have referred to the communication device 10 including two substrates: the antenna substrate 20A and the circuit substrate 30A, but however, the communication device 10 may be made of three or more substrates.

The first to third embodiments have referred to the dielectric layers 100a, 100b, 100c, and 100d each of which is made from a resin material, but however, they may alternatively be made from a ceramic material having a low electrical permittivity.

The first to third embodiments have referred to the communication device 10 equipped with the single the antenna layer 111, but however, the communication device 10 may alternatively be designed as a radar device which is, as illustrated in FIG. 54, equipped with the transmitting antenna layer 111a and the receiving antenna layer 111b.

Specifically, the communication device 10 illustrated in FIG. 54 includes the transmitting antenna layer 111a and the receiving antenna layer 111b. The transmitting antenna layer 111a and the receiving antenna layer 111b are electrically connected to the integrated circuit 200.

The integrated circuit 200 includes the arithmetic circuit 200a, the analog-to-digital converter 200b, the demodulating circuit 200c, and the signal generator 200f.

The signal generator 200f outputs a transmit signal to the transmitting antenna layer 111a. The transmitting antenna layer 111a emits the transmit signal in the form of an electromagnetic wave.

When the transmit signal is reflected by a target object existing around a vehicle equipped with the radar device implemented by the communication device 10, the receiving antenna layer 111b receives a reflected signal arising from reflection of the transmit signal on the target object. The receiving antenna layer 111b then outputs the reflected signal to the demodulating circuit 200c in the form of a received signal. The demodulating circuit 200c demodulates the received signal and outputs it to the arithmetic circuit 200a. The arithmetic circuit 200a then analyzes the demodulated signal to calculate a distance between the vehicle and the target object.

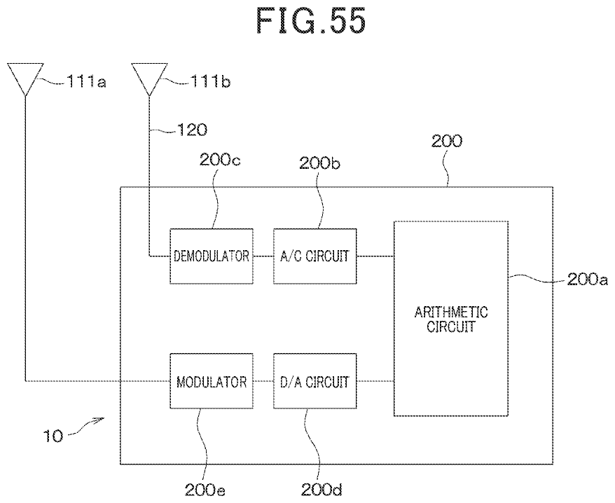

The communication device 10 equipped with the transmitting antenna layer 111a and the receiving antenna layer 111b may alternatively be, as illustrated in FIG. 55, used as a communication device other than the radar device.

Each of the transmitting antenna layer 111a and the receiving antenna layer 111b illustrated in FIG. 55 may be preferably designed to have a structure identical with that of the antenna layer 111 in the first embodiment. Specifically, the communication device 10 has two discrete antenna substrates: the transmitting antennal substrate 20A equipped with the transmitting antenna layer 111a and the receiving antennal substrate 20A equipped with the receiving antenna layer 111b.

The first to third embodiments have referred to the communication device 10 which has the antenna 110, the power feeding path 120, and the electromagnetic shield 130 which are made from a conductive material containing copper, but however, they may alternatively be made from a conductive material containing, for example, titanium or tungsten.

Similarly, each of the external connecting vias 280, 281, 282, 283, and 284, the power feeding electrode 285, and the ground electrodes 286 and 287 may alternatively be made from a conductive material containing titanium or tungsten.

The first to third embodiments have referred to the ground vias 131a, 131b, 131c, 131c, 132a, 132b, 132c, 132d, 133a, 133b, 133c, 134a, 134b, and 134c each of which is formed in a cylindrical shape, but however, they may alternatively be designed to have a prism or rectangular column shape.

The first to third embodiments have referred to the connecting flanged layers 124 and 126 each of which is of a circular disc shape, but however, they may alternatively be formed in a polygonal (e.g., square or rectangular) plate shape.

The first to third embodiments have referred to the antenna 110 designed as a transmitting-and-receiving antenna for use in emitting and receiving radio waves, but however, may alternatively be designed as a transmitting antennal specifically for outputting radio waves.

The first to third embodiments have referred to the production method of the antenna substrate 20A which stacks parts of the antenna substrate 20A on one another from the first side to the second side in the thickness direction Ya. The parts of the antenna substrate 20A include, for example, the ground layers 131, 132, 133, 134, and 135 and the dielectric layers 100a, 100b, 100c, and 100d. The antenna substrate 20A may alternatively be produced by sequentially stacking the parts on one another from the second side to the first side in the thickness direction Ya.

The first to third embodiments have discussed the orientation of the antenna substrate assembly 20 of the communication device 10 using the first and second sides in the thickness direction Ya. The first side is, as already described, defined as a region of the antenna substrate assembly 20 where the ground layer 131 is arranged, in other words, a portion of the antenna substrate assembly 20 which is located close to the ground layer 131 in the thickness direction Ya, while the second side is defined as a region of the antenna substrate assembly 20 where the ground layer 135 is arranged, in other words, a portion of the antenna substrate assembly 20 which is located close to the ground layer 135 in the thickness direction Ya. The second side may alternatively be defined as a portion of the antenna substrate assembly 20 which is located close to the ground layer 131 in the thickness direction Ya, while the first side may be defined as a portion of the antenna substrate assembly 20 which is located close to the ground layer 135 in the thickness direction Ya. In other words, the first side and the second side, as referred to herein, are used only for defining the orientations of the parts of the communication device 10 for the sake of convenience. The same is true for the width direction Yb and the depth direction Yc.

The component parts described in the above embodiments are not necessarily essential unless otherwise specified or viewed to be essential in principle. When the number of the component parts, a numerical number, a volume, or a range is referred to in the above discussion, this disclosure is not limited to it unless otherwise specified or viewed to be essential in principle. Similarly, when the shape of, the orientation of, or the positional relation among the component parts is referred to in the above discussion, this disclosure is not limited to it unless otherwise specified or clearly essential in principle.

What is claimed is:

1. A production method of a communication apparatus comprising:
forming an antenna substrate which includes a first insulating substrate, an antenna, and a power feeding path, the first insulating substrate being made from an electrically insulating material in a form of a plate, the antenna being mounted on the first insulating substrate, the power feeding path being arranged on or in the first insulating substrate in connection with the antenna;
forming a circuit substrate which is discrete from the antenna substrate, the circuit substrate including a second insulating substrate and a communication integrated circuit, the second insulating substrate being made from an electrically insulating material in a form of a plate, the circuit substrate being disposed in the second insulating substrate and having a power feeding terminal for connection of the circuit substrate with the antenna through the power feeding path, the communication integrated circuit working to emit a signal from the antenna or receive a signal through the antenna; and
joining the antenna substrate and the circuit substrate together simultaneously with connection of the power feeding terminal with the power feeding path.

2. The production method as set forth in claim 1, wherein the connection of the power feeding terminal of the communication integrated circuit with the power feeding path is achieved through a conductive member, and each of the power feeding terminal of the communication integrated circuit, the power feeding path, and the conductive member is made from a conductive material containing copper.

3. The production method as set forth in claim 1, wherein the forming the antenna substrate includes making an electromagnetically shielding conductor from a conductive material, the electromagnetically shielding conductor being connected to ground and surrounding the power feeding path from a first side and a second side of the communication apparatus which are opposed to each other in a crossing direction which crosses a thickness direction of the communication apparatus, and
the electromagnetically shielding conductor works to block leakage of an electromagnetic wave, as appearing in the power feeding path, outside a region surrounded by the electromagnetically shielding conductor or propagation of an electromagnetic wave, as coming from outside the region, to the power feeding path.

4. The production method as set forth in claim 3, wherein the forming the power feeding path includes forming a power feeding conductor which extends in a second crossing direction which traverses a first crossing direction that is the crossing direction crossing the thickness direction,
the forming the electromagnetically shielding conductor includes forming a first ground conductor and a second ground conductor, the first ground conductor being shaped in a form of a film which is arranged closer to a first side of the communication apparatus in the thickness direction than the power feeding conductor is in the thickness direction and spreads both in the first crossing direction and in the second crossing direction, the second ground conductor being shaped in a form of a film which is located closer to a second side opposed to the first side in the thickness direction than the power feeding conductor in the thickness direction and spreads both in the first crossing direction and in the second crossing direction, the first ground conductor works to block propagation of an electromagnetic wave, as appearing in the power feeding conductor, to
the first side in the thickness direction or block propagation of an electromagnetic wave, as traveling from the first side to the second side in the thickness direction, to the power feeding conductor, and the second ground conductor works to block propagation of an electromagnetic wave, as appearing in the power feeding conductor, to
the second side in the thickness direction or block propagation of an electromagnetic wave, as traveling from the second side to the first side in the thickness direction, to the power feeding conductor.

5. The production method as set forth in claim 4, the forming the electromagnetically shielding conductor includes forming a third ground conductor which surrounds the power feeding conductor both in the first crossing direction and in the second crossing direction.

6. The production method as set forth in claim 5, wherein the power feeding conductor is implemented by a first power feeding conductor,
the forming the power feeding path includes forming a second power feeding conductor which connects with the first power feeding conductor, and
the forming the electromagnetically shielding conductor includes forming a plurality of fourth ground conductors and a plurality of fifth ground conductors, the fourth ground conductors being located closer to the first side than the second power feeding conductor is in the first crossing direction and arranged in the second crossing direction, the fifth ground conductors being located closer to the second side than the second power feeding conductor is in the first crossing direction and arranged in the second crossing direction.

7. The production method as set forth in claim 6, wherein the forming the electromagnetically shielding conductor includes forming the plurality of fourth ground conductors to pass through the first insulating substrate in the thickness direction and forming the plurality of fifth ground electrodes to pass through the first insulating substrate in the thickness direction.

8. The production method as set forth in claim 7, wherein the forming the power feeding path includes forming the second power feeding conductor which is of a cylindrical shape centered at an axial line extending in the thickness direction, forming a connecting flanged layer which is of a plate shape centered at the axial line, located closer to the first side than the second power feeding conductor is in the thickness direction, and connects with the second power feeding conductor, and also forming a third power feeding conductor which is of a cylindrical shape, located closer to the first side than the connecting flanged layer in the thickness direction, and connects with the connecting flanged layer, and
the connecting flanged layer is shaped to extend to outside the second power feeding conductor and the third power feeding conductor in a radial direction of the axial line.

9. The production method as set forth in claim 1, wherein the forming the antenna substrate includes forming a first power feeding path, a first electromagnetically shielding conductor, and a second electromagnetically shielding conductor, the first power feeding path being provided by the power feeding path and made from a conductive material in a cylindrical shape centered at an axial line extending in the thickness direction, the first electromagnetically shielding conductor being located closer to the second side than the first power feeding path is in a first crossing direction that traverses the thickness direction, the second electromagnetically shielding conductor being located closer to the first side than the first power feeding path is in the first crossing direction, the first and second electromagnetically shielding conductors being made from a conductive material and extending in the thickness direction,
the forming the antenna substrate also includes (a) arranging an electrically insulating material to fully cover the first power feeding path, the first electromagnetically shielding conductor, and the second electromagnetically shielding conductor with ends of the first power feeding path, the first electromagnetically shielding conductor, and the second electromagnetically shielding conductor which face the second side in the thickness direction and are exposed outside the electrically insulating material and (b) shaping a portion of the electrically insulating material which faces the second side in the thickness direction and the ends of the first power feeding path, the first electromagnetically shielding conductor, and the second electromagnetically shielding conductor which face the second side in the thickness direction to be flat, thereby completing the first insulating substrate made from the electrically insulating material,
the forming the antenna substrate also includes forming a second power feeding path and a third electromagnetic shielding conductor, the second power feeding path being disposed on a portion of the first insulating substrate which faces the second side in the thickness direction, connecting with the first power feeding path, and formed in a shape of a film which is centered at the axial line and extends both in the first crossing direction and in a second crossing direction which traverses both the first crossing direction and the thickness direction, the third electromagnetic shielding conductor being arranged on a portion of the first insulating substrate which faces the second side in the thickness direction, connecting with the first electromagnetically shielding conductor and the second electromagnetically shielding conductor, and being formed in a shape of a film which spreads both in the first crossing direction and in the second crossing direction to surround the second power feeding path,
the second power feeding path having a flange which is centered at the axial line and extends outside the first power feeding path in a radial direction of the axial line,
the first electromagnetically shielding conductor and the second electromagnetically shielding conductor work to block leakage of an electromagnetic wave, as appearing in the first power feeding path, outside a region surrounded by the first electromagnetically shielding conductor and the second electromagnetically shielding conductor or block propagation of an electromagnetic wave, as coming from outside the region, to the first power feeding path, and
the third electromagnetic shielding conductor works to block propagation of an electromagnetic wave, as appearing in the second power feeding path, both in the first crossing direction and in the second crossing direction or prevent an electromagnetic wave, as traveling to the third electromagnetic shielding conductor from the first crossing direction or the second crossing direction, from being received by the second power feeding path.

10. The production method as set forth in claim 1, wherein the forming the antenna substrate includes forming a first power feeding path, a first electromagnetically shielding conductor, and a second electromagnetically shielding conductor, the first power feeding path being provided by the power feeding path and made from a conductive material in a cylindrical shape centered at an axial line extending in the thickness direction, the first electromagnetically shielding conductor being located closer to the first side than the first power feeding path is in a first crossing direction that traverses the thickness direction, the second electromagnetically shielding conductor being located closer to the second side opposed to the first side than the first power feeding path is in the first crossing direction, the first and second electromagnetically shielding conductors being made from a conductive material and extending in the thickness direction,
the forming the antenna substrate also includes (a) arranging an electrically insulating material to fully cover the first power feeding path, the first electromagnetically shielding conductor, and the second electromagnetically shielding conductor with ends of the first power feeding path, the first electromagnetically shielding conductor, and the second electromagnetically shielding conductor which face the second side in the thickness direction and are exposed outside the electrically insulating material and (b) shaping a portion of the electrically insulating material which faces the second side in the thickness direction and the ends of the first power feeding path, the first electromagnetically shielding conductor, and the second electromagnetically shielding conductor which face the second side in the thickness direction to be flat, thereby completing the first insulating substrate made from the electrically insulating material,
the forming the antenna substrate also includes forming a second power feeding path and a third electromagnetic shielding conductor, the second power feeding path being provided by the power feeding path, disposed on a portion of the first insulating substrate which faces the second side in the thickness direction, connecting with the first power feeding path, and extending in a second crossing direction which traverses both the first crossing direction and the thickness direction, the third electromagnetic shielding conductor being arranged on a portion of the first insulating substrate which faces the second side in the thickness direction, connecting with the first electromagnetically shielding conductor and the second electromagnetically shielding conductor, and being formed in a shape of a film which spreads both in the first crossing direction and in the second crossing direction to surround the second power feeding path,
the first electromagnetically shielding conductor and the second electromagnetically shielding conductor work to block leakage of an electromagnetic wave, as appearing in the first power feeding path, outside a region surrounded by the first electromagnetically shielding conductor and the second electromagnetically shielding conductor or block propagation of an electromagnetic wave, as coming from outside the region, to the first power feeding path, and
the third electromagnetic shielding conductor works to block propagation of an electromagnetic wave from the second power feeding path both in the first crossing direction and in the second crossing direction or prevent an electromagnetic wave, as traveling to the third electromagnetic shielding conductor from the first crossing direction or the second crossing direction, from being received by the second power feeding path.

11. The production method as set forth in claim 1, wherein the forming the antenna substrate includes forming first electromagnetically shielding conductors and second electromagnetically shielding conductors each of which is made from a conductive material, the first electromagnetically shielding conductors being arranged in a first crossing direction that traverses the thickness direction and extend in the thickness direction, the second electromagnetically shielding conductors being arranged in the first crossing direction and extend in the thickness direction,
the forming the antenna substrate also includes (a) arranging an electrically insulating material to fully cover the first electromagnetically shielding conductors and the second electromagnetically shielding conductors with ends of the first electromagnetically shielding conductors and the second electromagnetically shielding conductors which face the second side in the thickness direction and are exposed outside the electrically insulating material and (b) shaping a portion of the electrically insulating material which faces the second side in the thickness direction and the ends of the first electromagnetically shielding conductors, and the second electromagnetically shielding conductors which face the second side in the thickness direction to be flat, thereby completing the first insulating substrate made from the electrically insulating material,
the forming the antenna substrate includes forming an antenna layer and a third electromagnetic shielding conductor, the antenna layer being arranged on a portion of the first insulating substrate which faces the second side in the thickness direction, the antenna layer being located closer to the second side than the first electromagnetically shielding conductor in the first crossing direction and also closer to the first side than the second electromagnetically shielding conductor in the first crossing direction, the antenna layer being formed in a shape of a film which extends both in the first crossing direction and in the second crossing direction, the third electromagnetic shielding conductor being arranged on a portion of the first insulating substrate which faces the second side in the thickness direction, the third electromagnetic shielding conductor connecting with the first electromagnetically shielding conductor and the second electromagnetically shielding conductor and being formed in a shape of a film spreading both in the first crossing direction and in the second crossing direction to surround the antenna layer,
the first electromagnetically shielding conductor works to block propagation of an electromagnetic wave, as appearing in the antenna layer, to the first side in the first crossing direction or prevent an electromagnetic wave, as traveling from the first side in the first crossing direction to the first electromagnetically shielding conductor, from being received by the antenna layer,
the second electromagnetically shielding conductor works to block propagation of an electromagnetic wave, as appearing in the antenna layer, to the second side in the first crossing direction or prevent an electromagnetic wave, as traveling from the second side in the first crossing direction, from being received by the antenna layer, and
the third electromagnetic shielding conductor works to block propagation of an electromagnetic wave, as appearing in the antenna layer, in the first crossing direction or the second crossing direction or prevent an electromagnetic wave, as traveling toward the third electromagnetic shielding conductor in the first crossing direction or the second crossing direction, from being received by the antenna layer.

12. A production method of a communication apparatus comprising:
forming an antenna substrate which includes a first insulating substrate, an antenna, and a power feeding path, the first insulating substrate being made from an electrically insulating material in a form of a plate, the antenna being mounted on the first insulating substrate, the power feeding path being arranged on or in the first insulating substrate in connection with the antenna;
forming a communication integrated circuit which is discrete from the antenna substrate, the communication integrated circuit including a power feeding terminal for connection of the communication integrated circuit with the antenna through the power feeding path, the communication integrated circuit working to emit a signal from the antenna or receive a signal through the antenna; and
joining the antenna substrate and the communication integrated circuit together simultaneously with connection of the power feeding terminal with the power feeding path.

13. The production method as set forth in claim 12, wherein the connection of the power feeding terminal of the communication integrated circuit with the power feeding path is achieved through a conductive member, and each of the power feeding terminal of the communication integrated circuit, the power feeding path, and the conductive member is made from a conductive material containing copper.

14. The production method as set forth in claim 12, wherein the forming the antenna substrate includes making an electromagnetically shielding conductor from a conductive material, the electromagnetically shielding conductor being connected to ground and surrounding the power feeding path from a first side and a second side of the communication apparatus which are opposed to each other in a crossing direction which crosses a thickness direction of the communication apparatus, and
the electromagnetically shielding conductor works to block leakage of an electromagnetic wave, as appearing in the power feeding path, outside a region surrounded by the electromagnetically shielding conductor or propagation of an electromagnetic wave, as coming from outside the region, to the power feeding path.

15. The production method as set forth in claim 14, wherein the forming the power feeding path includes forming a power feeding conductor which extends in a second crossing direction which traverses a first crossing direction that is the crossing direction crossing the thickness direction,
the forming the electromagnetically shielding conductor includes forming a first ground conductor and a second ground conductor, the first ground conductor being shaped in a form of a film which is arranged closer to a first side of the communication apparatus in the thickness direction than the power feeding conductor is in the thickness direction and spreads both in the first crossing direction and in the second crossing direction, the second ground conductor being shaped in a form of a film which is located closer to a second side opposed to the first side in the thickness direction than the power feeding conductor in the thickness direction and spreads both in the first crossing direction and in the second crossing direction,
the first ground conductor works to block propagation of an electromagnetic wave, as appearing in the power feeding conductor, to the first side in the thickness direction or block propagation of an electromagnetic wave, as traveling from the first side to the second side in the thickness direction, to the power feeding conductor, and
the second ground conductor works to block propagation of an electromagnetic wave, as appearing in the power feeding conductor, to the second side in the thickness direction or block propagation of an electromagnetic wave, as traveling from the second side to the first side in the thickness direction, to the power feeding conductor.

16. The production method as set forth in claim 15, the forming the electromagnetically shielding conductor includes forming a third ground conductor which surrounds the power feeding conductor both in the first crossing direction and in the second crossing direction.

17. The production method as set forth in claim 16, wherein the power feeding conductor is implemented by a first power feeding conductor,
the forming the power feeding path includes forming a second power feeding conductor which connects with the first power feeding conductor, and
the forming the electromagnetically shielding conductor includes forming a plurality of fourth ground conductors and a plurality of fifth ground conductors, the fourth ground conductors being located closer to the first side than the second power feeding conductor is in the first crossing direction and arranged in the second crossing direction, the fifth ground conductors being located closer to the second side than the second power feeding conductor is in the first crossing direction and arranged in the second crossing direction.

18. The production method as set forth in claim 17, wherein the forming the electromagnetically shielding conductor includes forming the plurality of fourth ground conductors to pass through the first insulating substrate in the thickness direction and forming the plurality of fifth ground electrodes to pass through the first insulating substrate in the thickness direction.

19. The production method as set forth in claim 18, wherein the forming the power feeding path includes forming the second power feeding conductor which is of a cylindrical shape centered at an axial line extending in the thickness direction, forming a connecting flanged layer which is of a plate shape centered at the axial line, located closer to the first side than the second power feeding conductor is in the thickness direction, and connects with the second power feeding conductor, and also forming a third power feeding conductor which is of a cylindrical shape, located closer to the first side than the connecting flanged layer in the thickness direction, and connects with the connecting flanged layer, and
the connecting flanged layer is shaped to extend to outside the second power feeding conductor and the third power feeding conductor in a radial direction of the axial line.

20. The production method as set forth in claim 12, wherein the forming the antenna substrate includes forming a first power feeding path, a first electromagnetically shielding conductor, and a second electromagnetically shielding conductor, the first power feeding path being provided by the power feeding path and made from a conductive material in a cylindrical shape centered at an axial line extending in the thickness direction, the first electromagnetically shielding conductor being located closer to the second side than the first power feeding path is in a first crossing direction that traverses the thickness direction, the second electromagnetically shielding conductor being located closer to the first side than the first power feeding path is in the first crossing direction, the first and second electromagnetically shielding conductors being made from a conductive material and extending in the thickness direction,
the forming the antenna substrate also includes (a) arranging an electrically insulating material to fully cover the first power feeding path, the first electromagnetically shielding conductor, and the second electromagnetically shielding conductor with ends of the first power feeding path, the first electromagnetically shielding conductor, and the second electromagnetically shielding conductor which face the second side in the thickness direction and are exposed outside the electrically insulating material and (b) shaping a portion of the electrically insulating material which faces the second side in the thickness direction and the ends of the first power feeding path, the first electromagnetically shielding conductor, and the second electromagnetically shielding conductor which face the second side in the thickness direction to be flat, thereby completing the first insulating substrate made from the electrically insulating material,
the forming the antenna substrate also includes forming a second power feeding path and a third electromagnetic shielding conductor, the second power feeding path being disposed on a portion of the first insulating substrate which faces the second side in the thickness direction, connecting with the first power feeding path, and formed in a shape of a film which is centered at the axial line and extends both in the first crossing direction and in a second crossing direction which traverses both the first crossing direction and the thickness direction, the third electromagnetic shielding conductor being arranged on a portion of the first insulating substrate which faces the second side in the thickness direction, connecting with the first electromagnetically shielding conductor and the second electromagnetically shielding conductor, and being formed in a shape of a film which spreads both in the first crossing direction and in the second crossing direction to surround the second power feeding path,
the second power feeding path having a flange which is centered at the axial line and extends outside the first power feeding path in a radial direction of the axial line,
the first electromagnetically shielding conductor and the second electromagnetically shielding conductor work to block leakage of an electromagnetic wave, as appearing in the first power feeding path, outside a region surrounded by the first electromagnetically shielding conductor and the second electromagnetically shielding conductor or block propagation of an electromagnetic wave, as coming from outside the region, to the first power feeding path, and
the third electromagnetic shielding conductor works to block propagation of an electromagnetic wave, as appearing in the second power feeding path, both in the first crossing direction and in the second crossing direction or prevent an electromagnetic wave, as traveling to the third electromagnetic shielding conductor from the first crossing direction or the second crossing direction, from being received by the second power feeding path.

21. The production method as set forth in claim 12, wherein the forming the antenna substrate includes forming a first power feeding path, a first electromagnetically shielding conductor, and a second electromagnetically shielding conductor, the first power feeding path being provided by the power feeding path and made from a conductive material in a cylindrical shape centered at an axial line extending in the thickness direction, the first electromagnetically shielding conductor being located closer to the first side than the first power feeding path is in a first crossing direction that traverses the thickness direction, the second electromagnetically shielding conductor being located closer to the second side opposed to the first side than the first power feeding path is in the first crossing direction, the first and second electromagnetically shielding conductors being made from a conductive material and extending in the thickness direction,
the forming the antenna substrate also includes (a) arranging an electrically insulating material to fully cover the first power feeding path, the first electromagnetically shielding conductor, and the second electromagnetically shielding conductor with ends of the first power feeding path, the first electromagnetically shielding conductor, and the second electromagnetically shielding conductor which face the second side in the thickness direction and are exposed outside the electrically insulating material and (b) shaping a portion of the electrically insulating material which faces the second side in the thickness direction and the ends of the first power feeding path, the first electromagnetically shielding conductor, and the second electromagnetically shielding conductor which face the second side in the thickness direction to be flat, thereby completing the first insulating substrate made from the electrically insulating material,
the forming the antenna substrate also includes forming a second power feeding path and a third electromagnetic shielding conductor, the second power feeding path being provided by the power feeding path, disposed on a portion of the first insulating substrate which faces the second side in the thickness direction, connecting with the first power feeding path, and extending in a second crossing direction which traverses both the first crossing direction and the thickness direction, the third electromagnetic shielding conductor being arranged on a portion of the first insulating substrate which faces the second side in the thickness direction, connecting with the first electromagnetically shielding conductor and the second electromagnetically shielding conductor, and being formed in a shape of a film which spreads both in the first crossing direction and in the second crossing direction to surround the second power feeding path,
the first electromagnetically shielding conductor and the second electromagnetically shielding conductor work to block leakage of an electromagnetic wave, as appearing in the first power feeding path, outside a region surrounded by the first electromagnetically shielding conductor and the second electromagnetically shielding conductor or block propagation of an electromagnetic wave, as coming from outside the region, to the first power feeding path, and
the third electromagnetic shielding conductor works to block propagation of an electromagnetic wave from the second power feeding path both in the first crossing direction and in the second crossing direction or prevent an electromagnetic wave, as traveling to the third electromagnetic shielding conductor from the first crossing direction or the second crossing direction, from being received by the second power feeding path.

22. The production method as set forth in claim 12, wherein the forming the antenna substrate includes forming first electromagnetically shielding conductors and second electromagnetically shielding conductors each of which is made from a conductive material, the first electromagnetically shielding conductors being arranged in a first crossing direction that traverses the thickness direction and extend in the thickness direction, the second electromagnetically shielding conductors being arranged in the first crossing direction and extend in the thickness direction,
the forming the antenna substrate also includes (a) arranging an electrically insulating material to fully cover the first electromagnetically shielding conductors and the second electromagnetically shielding conductors with ends of the first electromagnetically shielding conductors and the second electromagnetically shielding conductors which face the second side in the thickness direction and are exposed outside the electrically insulating material and (b) shaping a portion of the electrically insulating material which faces the second side in the thickness direction and the ends of the first electromagnetically shielding conductors, and the second electromagnetically shielding conductors which face the second side in the thickness direction to be flat, thereby completing the first insulating substrate made from the electrically insulating material,
the forming the antenna substrate includes forming an antenna layer and a third electromagnetic shielding conductor, the antenna layer being arranged on a portion of the first insulating substrate which faces the second side in the thickness direction, the antenna layer being located closer to the second side than the first electromagnetically shielding conductor in the first crossing direction and also closer to the first side than the second electromagnetically shielding conductor in the first crossing direction, the antenna layer being formed in a shape of a film which extends both in the first crossing direction and in the second crossing direction, the third electromagnetic shielding conductor being arranged on a portion of the first insulating substrate which faces the second side in the thickness direction, the third electromagnetic shielding conductor connecting with the first electromagnetically shielding conductor and the second electromagnetically shielding conductor and being formed in a shape of a film spreading both in the first crossing direction and in the second crossing direction to surround the antenna layer,
the first electromagnetically shielding conductor works to block propagation of an electromagnetic wave, as appearing in the antenna layer, to the first side in the first crossing direction or prevent an electromagnetic wave, as traveling from the first side in the first crossing direction to the first electromagnetically shielding conductor, from being received by the antenna layer,
the second electromagnetically shielding conductor works to block propagation of an electromagnetic wave, as appearing in the antenna layer, to the second side in the first crossing direction or prevent an electromagnetic wave, as traveling from the second side in the first crossing direction, from being received by the antenna layer, and
the third electromagnetic shielding conductor works to block propagation of an electromagnetic wave, as appearing in the antenna layer, in the first crossing direction or the second crossing direction or prevent an electromagnetic wave, as traveling toward the third electromagnetic shielding conductor in the first crossing direction or the second crossing direction, from being received by the antenna layer.
